(19) United States
(12) Patent Application Publication
(10) Pub. No.: US 2012/0299469 A1
(43) Pub. Date: Nov. 29, 2012

(54) ELECTROLUMINESCENT ELEMENT, METHOD FOR MANUFACTURING ELECTROLUMINESCENT ELEMENT, DISPLAY DEVICE AND ILLUMINATING DEVICE

(75) Inventors: Kunio Kondo, Minato-ku (JP); Kanjiro Sako, Minato-ku (JP); Masaru Tajima, Minato-ku (JP); Katsumasa Hirose, Minato-ku (JP)

(73) Assignee: SHOWA DENKO K.K., Tokyo (JP)

(21) Appl. No.: 13/519,599

(22) PCT Filed: Dec. 21, 2010
(86) PCT No.: PCT/JP2010/072982

§ 371 Date: Aug. 13, 2012

(30) Foreign Application Priority Data
Dec. 28, 2009 (JP) 2009-298594

(51) Int. Cl. H05B 33/12; H05B 33/10

(52) U.S. Cl. 313/504; 313/498; 445/58

(57) ABSTRACT

Disclosed is an electroluminescent element (10) which includes an anode layer (12), a cathode layer (14), a first low refractive index layer (13) that is formed between the anode layer (12) and the cathode layer (14), a recessed portion (16) that penetrates at least the anode layer (12) and the first low refractive index layer (13), a second low refractive index layer (19) that is formed on the bottom of the recessed portion (16), and a light emitting portion (17) that is formed on the second low refractive index layer (19). The electroluminescent element (10) is also characterized in that the refractive index of the first low refractive index layer (13) and the refractive index of the second low refractive index layer (19) are lower than the refractive index of the light emitting portion (17). The electroluminescent element (10) provides an electroluminescent element which has high light-emitting efficiency when the light emitted from the light emitting portion is taken out from the substrate side.

### TECHNICAL FIELD

The present invention relates to an electroluminescent element or the like used for, for example, a display device or an illuminating device.

### BACKGROUND ART

In recent years, devices utilizing the electroluminescence phenomenon have increased in importance. As such a device, an electroluminescent element in which light-emitting materials are formed to be a light-emitting layer, and a pair of electrodes including an anode and a cathode is attached to the light-emitting layer, and light is emitted by applying a voltage thereto, becomes a focus of attention. In this kind of electroluminescent element, holes and electrons are injected from the anode and the cathode, respectively, by applying a voltage between the anode and the cathode, and an energy generated by coupling the injected electrons and holes in the light-emitting layer is used to perform light emission. In other words, the electroluminescent element is a device utilizing a phenomenon in which the light-emitting material of the light-emitting layer is excited by the energy produced by the coupling, and light is emitted when an excited state returns to a ground state again.

In the case where the electroluminescent element is used as a display device, since the light-emitting material is capable of self-emitting, the device has characteristics that a response speed as the display device is fast and a view angle is wide. Further, due to its structural feature of the electroluminescent element, there is an advantage that the thickness of the display device may be reduced with ease. Moreover, in the case of an organic electroluminescent element using, for example, an organic substance as the light-emitting material, characteristics are obtained such that light with high color purity is readily obtained depending upon selection of the organic substance, and thereby a wide color gamut is available.

Further, since the electroluminescent element is capable of emitting white light, and is an area light source, usage of the electroluminescent element to be incorporated into an illuminating device is suggested.

As an example of such an electroluminescent element, Patent Document 1, for example, suggests a cavity-emission electroluminescent device that includes a dielectric layer interposed between a hole-injecting and electron-injecting electrode layers, and in which an electroluminescent coating material is applied to an interior cavity surface extending through at least the dielectric layer and one of the electrode layers and including a hole-injecting electrode region, an electron-injecting electrode region and a dielectric region.

Further, Patent Document 2 discloses an organic electroluminescent device in which low refractive index regions made of materials having a refractive index less than that of a substrate are provided to be adjacent to the light-emitting regions.

### CITATION LIST

### Patent Literature

Patent Document 1: Japanese Patent Application Unexamined Publication (Translation of PCT Application) No. 2003-522371
Patent Document 2: U.S. Patent Application Publication No. US 2008/0238310 A1

### DISCLOSURE OF INVENTION

### Technical Problem

In general, a cavity-emission electroluminescence device is easy to increase outcoupling efficiency since light emitted from an electroluminescence coating material is made to be directly extracted through the cavity. However, in the case where the light is intended to be extracted from the substrate side, the outcoupling efficiency is decreased in some cases since reflection is easy to occur on the surface of the substrate depending on an angle of the light reaching the output surface of the substrate.

Further, as a method for forming a cavity structure, there is a case where an etching is performed for patterning an electrode on a substrate side and an insulating layer. At this time, the etching process tends to be complicated since the etching conditions of the insulating layer and the electrode are different from each other in general. Moreover, since the etching condition of the electrode is generally stricter than that of the insulating layer, a resist used as a mask is required to be thick. Therefore, there has been a disadvantage that the time required for resist formation and etching tends to be long. As a result, it was difficult to stably produce an expected shape. Furthermore, since there is a limitation in material selectivity that only the materials that are able to be etched can be used as the insulating layer, there has been a case where a transparent and low refractive index material cannot be used.

In addition, in an organic electroluminescent device in which a low refractive index area having a lower refractive index than a substrate is provided adjacently to the light emitting area, an electrode layer made of indium tin oxide (hereinafter, referred to as ITO) is located below the low refractive index area. Since the light transmission of the ITO is smaller than that of the low refractive index area, light entering into the electrode layer from the low refractive index area is heavily attenuated in intensity. Furthermore, since ITO has a high refractive index, the light entering into the electrode layer tends to be confined within the electrode layer by total reflection. Therefore, light extraction efficiency is lowered.

An object of the present invention is to provide an electroluminescent element and the like which has high light-emitting efficiency when the light emitted from the light emitting section is extracted from the substrate side.

### Solution to Problem

An electroluminescent element according to the present invention includes; a first electrode layer; a second electrode layer; a first low refractive index layer that is formed between the first electrode layer and the second electrode layer; a recessed portion that penetrates at least the first electrode layer and the first low refractive index layer; a second low refractive index layer that is formed on a bottom portion of the recessed portion; and a light emitting portion that is formed on the second low refractive index layer, and a refractive index of the first low refractive index layer and a refractive index of the second low refractive index layer are smaller than a refractive index of the light emitting portion.

Here, the recessed portion includes a “penetrating part” and a “bored part.” The “penetrating part” of the recessed portion indicates a portion from a boundary surface between the first electrode layer and a substrate to a light emitting side, and the “bored part” of the recessed portion indicates a portion from a boundary surface between the first electrode layer and a substrate to a substrate side. However, it should be noted that the bored part is not necessarily provided in the exemplary embodiment.

It is preferable that the recessed portion is formed 10² or more per 1 mm² in the substrate, and more preferably 10⁴ to 10⁸. If the density of the recessed portion is too low, it is difficult to obtain brightness, on the other hand, if the density of the recessed portion is too high, the light emitting efficiency is lowered since the recessed portion is overlapped and is not able to be scattered.

In the present invention, an area of the recessed portion may be a laminated configuration. Further, a layer in which charge is moved to the light emitting portion may be provided. “Light emitting portion” includes a portion between the electrode of these layers and a light emitting area (a portion where the charge related to emitting light moves). That is, the light emitting portion may be formed of one layer or a laminated configuration having two or more layers. For example, the light emitting portion includes a light emitting layer, and further includes one layer or two or more layers selected from; a charge injecting layer; a charge moving layer; and a charge blocking layer.

Here, a thickness of a first low refractive index layer and a thickness of a second low refractive index layer may be preferably 10 nm to 500 nm, and more preferably 50 nm to 200 nm. Further, a thickness of the first low refractive index layer is preferably thinner than a thickness of the second low refractive index layer, and the first low refractive index layer preferably has insulating properties.

The light emitting portion may be in contact with a side surface of the first electrode layer, and the light emitting portion may be further in contact with an upper surface of the first electrode layer. The light emitting portion preferably contains a phosphorescent light-emitting organic material.

A width of the recessed portion is preferably 10 μm or less, and the recessed portion preferably has a cylinder shape or a trench shape being parallel to each other. Further, a substrate on which the first electrode layer is formed may be provided, and the recessed portion may include a penetrating part that is formed to penetrate at least the first electrode layer and the first low refractive index layer, and a bored part that is formed in the substrate.

Further, a method for manufacturing electroluminescent element according to the present invention includes: a first electrode layer forming process in which a first electrode layer is formed on a substrate; a recessed portion forming process in which a recessed portion is formed in the first electrode layer before a first low refractive index layer and a second low refractive index layer are formed; a second low refractive index layer forming process in which the second low refractive index layer is formed on a bottom surface of the recessed portion; a first low refractive index layer forming process in which the first low refractive index layer is formed on the first electrode layer; a light emitting portion forming process in which a light emitting portion containing a light-emitting material is formed on the first low refractive index layer and the second low refractive index layer; and a second electrode layer forming process in which a second electrode layer is formed on the light-emitting material.

Further, a method for manufacturing electroluminescent element according to the present invention includes: a first electrode layer forming process in which a first electrode layer is formed on a substrate; a recessed portion forming process in which a recessed portion is formed in the first electrode layer; a low refractive index layer forming process in which a first low refractive index layer and a second low refractive index layer are formed together; a light emitting portion forming process in which a light emitting portion containing a light-emitting material is formed on the first low refractive index layer and the second low refractive index layer; and a second electrode layer forming process in which a second electrode layer is formed on the light-emitting material.

Here, a film thinning process in which a thickness of the second low refractive index layer is made small may be provided between the low refractive index layer forming process and the light emitting portion forming process, and an electrode layer exposure process in which a part of the first electrode layer is exposed may be provided between the film thinning process and the light emitting portion forming process. In the recessed portion forming process, the recessed portion may be formed by penetrating the first electrode layer and the substrate together.

A display device according to the present invention includes the electroluminescent element described above.

An illuminating device according to the present invention includes the electroluminescent element described above.

### Advantageous Effects of Invention

An object of the present invention is to provide an electroluminescent element and the like which has high light-emitting efficiency when the light emitted from the light emitting section is extracted from the substrate side.

### BRIEF DESCRIPTION OF DRAWINGS

FIG. 1 is a partial cross-sectional view for illustrating a first specific example of an electroluminescent element to which the exemplary embodiment is applied;

FIG. 2 is a diagram for illustrating a path of light emitted from the light emitting portion;

FIGS. 3A to 3C illustrate and explain other modes of the light emitting portion in the electroluminescent element to which the exemplary embodiment is applied;

FIG. 4 is a partial cross-sectional view illustrating a fifth specific example of an electroluminescent element to which the exemplary embodiment is applied;

FIG. 5 is a partial cross-sectional view illustrating a sixth specific example of an electroluminescent element to which the exemplary embodiment is applied;

FIG. 6 is a partial cross-sectional view illustrating a seventh specific example of an electroluminescent element to which the exemplary embodiment is applied;

FIG. 7 is a partial cross-sectional view illustrating an eighth specific example of an electroluminescent element to which the exemplary embodiment is applied;

FIGS. 8A to 8G are diagrams for illustrating the manufacturing method of the electroluminescent element to which the exemplary embodiment is applied;

FIG. 9 is a diagram for illustrating an example of a display device using the electroluminescent element according to the exemplary embodiment;

FIG. 10 is a diagram for illustrating an example of an illuminating device having the electroluminescent element according to the exemplary embodiment;

FIG. 11 illustrates an electroluminescent element according to a comparative example 1; and

FIG. 12 illustrates an electroluminescent element according to a comparative example 3.

### DESCRIPTION OF EMBODIMENTS

### (Electroluminescent Element)

Hereinafter, an exemplary embodiment of the present invention will be described in detail with reference to the attached drawings.

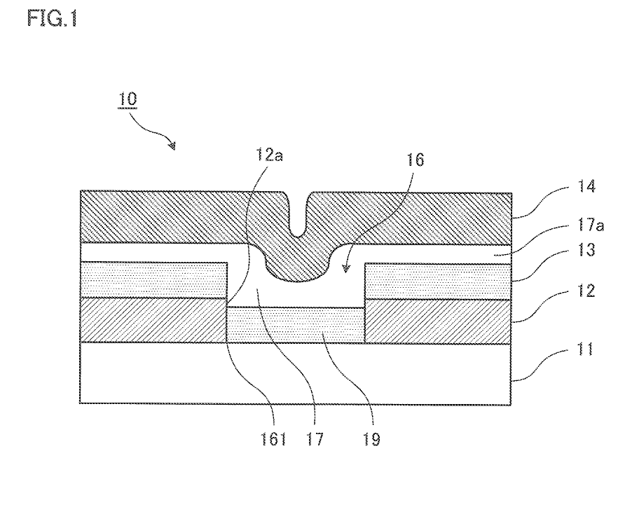

FIG. 1 is a partial cross-sectional view for illustrating a first specific example of an electroluminescent element to which the exemplary embodiment is applied.

An electroluminescent element 10 shown in FIG. 1 has a configuration in which a substrate 11, an anode layer 12 as a first electrode layer for injecting holes, which is formed on the substrate 11 in a case where the substrate 11 side is set to be the downside, a cathode layer 14 as a second electrode layer for injecting electrons, and a first low refractive index layer 13 formed between the anode layer 12 and the cathode layer 14 are stacked. Further, the electroluminescent element 10 has a recessed portion 16 formed by penetrating the anode layer 12 and the first low refractive index layer 13, and a second low refractive index layer 19 is formed at a bottom portion of the recessed portion 16. Furthermore, the electroluminescent element 10 includes a light emitting portion 17 which is formed on the second low refractive index layer 19 provided at an inner surface of the recessed portion 16 and is made of a light-emitting material emitting light with application of voltage. The light-emitting material constituting the light emitting portion 17 extends from the recessed portion 16 to the top surface of the first low refractive index layer 13 to form an extension portion 17a. In other words, the light-emitting material constituting the light emitting portion 17 is successively formed to extend from the recessed portion 16 to a section between the first low refractive index layer 13 and the cathode layer 14. The cathode layer 14 is formed on the light-emitting material, and laminated as a so-called uniform film.

The substrate 11 is a base material that serves as a support body for forming the anode layer 12, the first low refractive index layer 13, the cathode layer 14, the light emitting portion 17 and the second low refractive index layer 19. For the substrate 11, a material that satisfies mechanical strength required for the electroluminescent element 10 is used.

The material for the substrate 11, in the case where the light is to be taken out from the substrate 11 side of the electroluminescent element 10, is required to be transparent to the visible light. Specific examples include: glasses such as sapphire glass, lime-soda glass and quartz glass; transparent resins such as acrylic resins, methacrylic resins, polycarbonate resins, polyester resins and nylon resins; silicon resins; and transparent metallic oxide such as aluminum nitride and alumina. In a case of using, as the substrate 11, a resin film or the like made of the aforementioned transparent resins, it is preferable that permeability to gas such as moisture and oxygen is low. In a case of using a resin film or the like having high permeability to gas, a thin film having a barrier property for inhibiting permeation of gas is preferably formed as long as the light transmission is not lost.

In the case where it is unnecessary to take out the light from the substrate 11 side of the electroluminescent element 10, the material of the substrate 11 is not limited to the ones which are transparent to the visible light, and may be opaque to the visible light. The specific examples of the material of the substrate 11 include: in addition to the above-described materials, a simple substances such as silicon (Si), copper (Cu), silver (Ag), gold (Au), platinum (Pt), tungsten (W), titanium (Ti), tantalum (Ta) and niobium (Nb); alloys thereof; stainless steel; oxides such as SiO₂, Al₂O₃ and the like; and a semiconductor material such as n-Si and the like.

Although the thickness of the substrate 11 depends on the required mechanical strength, it is preferably 0.1 mm to 10 mm, and more preferably 0.25 mm to 2 mm.

Voltage is applied between the anode layer 12 and the cathode layer 14, and holes are injected from the anode layer 12 to the light emitting portion 17. A material used for the anode layer 12 is necessary to have electric conductivity. Specifically, it has a low work function, and the work function is preferably not less than 4.5 eV. In addition, it is preferable that the electric resistance is not notably changed for an alkaline aqueous solution.

As the material satisfying such requirements, metal oxides, metals or alloys can be used. As the metal oxides, indium tin oxide (ITO) and indium zinc oxide (IZO) are provided, for example. As the metals, provided are: copper (Cu); silver (Ag); gold (Au); platinum (Pt); tungsten (W); titanium (Ti); tantalum (Ta); niobium (Nb) and the like. Further, alloys such as stainless steel including these metals can be used. The thickness of the anode layer 12 is formed to be, for example, 2 nm to 2 μm. Note that, the work function can be measured by, for example, an ultraviolet photoelectron spectroscopy.

The first low refractive index layer 13 refracts the light emitted from the light emitting portion 17, so that the light easily enters into the substrate 11.

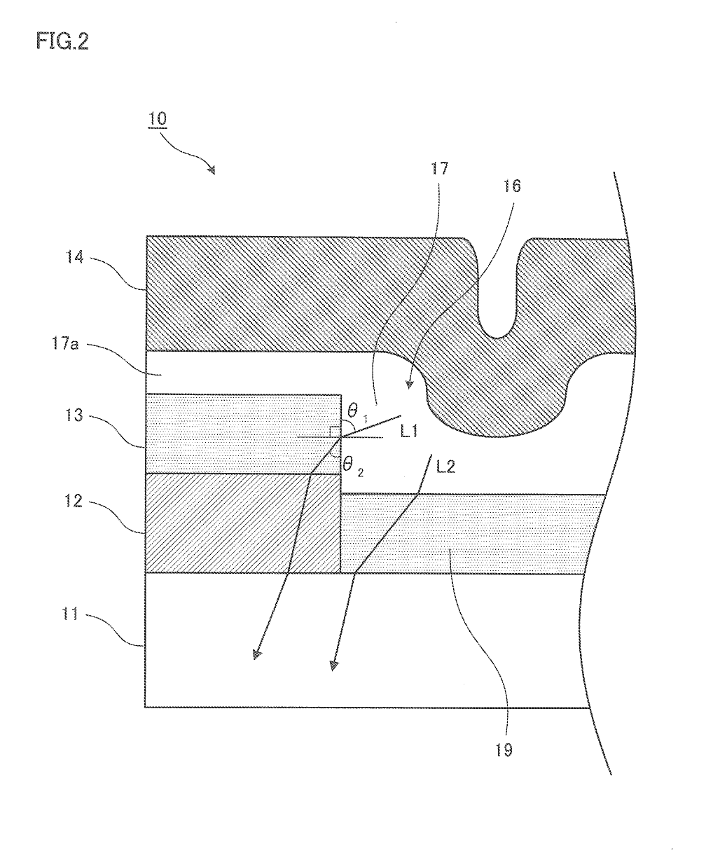

In the exemplary embodiment, the refractive index of the first low refractive index layer 13 is lower than that of the light emitting portion 17. Therefore, as shown in FIG. 2 (a diagram for illustrating a path of light emitted from the light emitting portion 17), a light L1 emitted from the light emitting portion 17 is refracted at an angle closer to the normal direction of the substrate 11 when the light L1 enters into the first low refractive index layer 13. That is, θ₁>θ₂ is satisfied in FIG. 2. As a result, compared to a case in which the first low refractive index layer 13 is not provided, total reflection of the light L1 having reached the anode layer 12 or the substrate 11 is not likely to occur at a boundary surface between the first low refractive index layer 13 and the anode layer 12 and at a boundary surface between the anode layer 12 and the substrate 11. Accordingly, the light L1 tends to enter the anode layer 12 or the substrate 11. In other words, by providing the first low refractive index layer 13, the light emitted from the light emitting portion 17 can be extracted more from a substrate 11 side, thereby the light extraction efficiency is improved.

In the exemplary embodiment, the first low refractive index layer 13 preferably has insulating properties. By having insulating properties, the first low refractive index layer 13 can separate the anode layer 12 from the cathode layer 14 with a predetermined gap therebetween and insulate them, while making the light emitting portion 17 emit light by applying a voltage to the light emitting portion 17. Thus, the first low refractive index layer 13 is preferably made of a material having high resistivity. The electric resistivity thereof is required to be not less than 10⁸ Ωcm, and preferably not less than 10¹² Ωcm. Specific examples of the material include: metal nitrides such as silicon nitride, boron nitride and aluminum nitride; metal oxides such as silicon oxide (silicon dioxide) and aluminum oxide; and metal fluorides such as sodium fluoride, lithium fluoride, magnesium fluoride, calcium fluoride and barium fluoride; and in addition, polymer compounds such as polyimide, polyvinylidene fluoride and parylene; and coating-type silicone such as poly (phenylsilsesquioxane) can be used.

Here, in order to manufacture, with high reproducibility, the electroluminescent element 10 that is less likely to be short-circuited and less likely to leak a current, the thicker the thickness of the first low refractive index layer 13 is, the better. That is, as the thickness of the first low refractive index layer 13 is thicker, it is easy to exclude or suppress influence of defects of the first low refractive index layer 13 causing the short-circuit and the current leakage. Causes of such a short-circuit and a current leakage include; a dust attached onto the substrate 11 right before the first low refractive index layer 13 is formed thereon; and a pinhole of the first low refractive index layer 13 which may occur in the manufacturing process of the first low refractive index layer 13.

On the other hand, the thickness of the first low refractive index layer 13 is preferably not more than 1 μm in order to suppress the entire thickness of the electroluminescent element 10. In addition, since the voltage necessary to emit light is lower as the distance between the anode layer 12 and the cathode layer 14 is shorter, the first low refractive index layer 13 is preferably thin from this viewpoint. However, if it is too thin, dielectric strength becomes possibly insufficient against the voltage for driving the electroluminescent element 10. Here, the dielectric strength is preferably not more than 0.1 mA/cm² in current density of a current passing between the anode layer 12 and the cathode layer 14 in the state where the light emitting portion 17 is not formed, and more preferably not more than 0.01 mA/cm². Further, since the first low refractive index layer 13 preferably endure the voltage more than 2V for the driving voltage of the electroluminescent element 10, for example, in the case where the driving voltage is 5V, the aforementioned current density is necessary to be achieved when the voltage of about 7V is applied between the anode layer 12 and the cathode layer 14 in the state where the light emitting portion 17 is not formed. The thickness of the first low refractive index layer 13 that satisfies these requirements is preferably not more than 750 nm as the upper limit, more preferably not more than 400 nm, and still more preferably not more than 200 nm. The thickness of the first low refractive index layer 13 is preferably not less than 15 nm as the lower limit, more preferably not less than 30 nm, and still more preferably not less than 50 nm.

The cathode layer 14 injects electrons into the light emitting portion 17 upon application of voltage between the anode layer 12 and the cathode layer 14. In the exemplary embodiment, since the recessed portion 16 is filled with the light-emitting materials, forms the light emitting portion 17 and the light-emitting materials are spread on the first low refractive index layer 13, the cathode layer 14 is formed on the light-emitting materials like a so-called uniform film. In other words, the cathode layer 14 does not have any hole portion penetrated by the recessed portion 16, and is formed as a continuous film not penetrated by the recessed portion 16.

The material used for the cathode layer 14 is not particularly limited as long as, similarly to that of the anode layer 12, the material has electrical conductivity; however, it is preferable that the material has a low work function and is chemically stable. In view of the chemical stability, it is preferable to use materials having a work function of not more than 2.9 eV. The specific examples of the material include Al, MgAg alloy and alloys of Al and alkali metals such as AlLi and AlCa. The thickness of the cathode layer 14 is preferably in the range of 10 nm to 1 μm, and more preferably 50 nm to 500 nm. In a case of the electroluminescent element 10 of the exemplary embodiment, light emitted from the light emitting portion 17 is extracted from the substrate 11 side. Therefore, the cathode layer 14 may be formed by an opaque material. Note that, if light is intended to be extracted from not only the substrate 11 side but also the cathode layer 14 side by using the configuration of the cathode layer 14 as an uniform film covering the light emitting portion 17 as shown in the exemplary embodiment, the cathode layer 14 is necessary to be made of a transparent material such as ITO.

To lower the barrier for the electron injection from the cathode layer 14 into the light emitting portion 17 and thereby to increase the electron injection efficiency, a cathode buffer layer that is not shown may be provided adjacent to the cathode layer 14. The cathode buffer layer is required to have a lower work function than the cathode layer 14, and metallic materials may be used therefor. For example, the material thereof includes alkali metals (Na, K, Rb and Cs), alkaline earth metals (Sr, Ba, Ca and Mg), rare earth metals (Pr, Sm, Eu and Yb), one selected from fluoride, chloride and oxide of these metals and mixture of two or more selected therefrom. The thickness of the cathode buffer layer is preferably in the range of 0.05 nm to 50 nm, more preferably 0.1 nm to 20 nm, and still more preferably 0.5 nm to 10 nm.

To lower the barrier for the electron injection from the cathode layer 14 into the light emitting portion 17 and thereby to increase the electron injection efficiency, an electron transporting layer (not shown in the figures) as an organic semiconductor layer that includes materials composed of organic materials may be further provided between the cathode buffer layer and the light emitting portion 17.

The material which can be used for the electron transporting layer includes; quinolinic derivatives, oxiadiazole derivatives, perylene derivatives, pyridine derivatives, pyrimidine derivatives, quinoxaline derivatives, diphenylquinone derivatives, nitro displacement fluorene derivatives or the like. More specifically, tris(8-quinolinolato)aluminium, tris(4-methyl-8-quinolinolato) aluminium, bis(10-hydroxybenzo[h]quinolinato) beryllium, bis(2-methyl-8-quinolinolato) (4-phenylphenolato) aluminium, bis[2-(2-hydroxyphenyl)benzooxazolato]zinc, bis[2-(2-hydroxyphenyl)benzothiazolato]zinc, 2-(4-biphenylyl)-5-(4-tert-butylphenyl)-1,3,4-oxadiazol, 1,3-bis[5-(p-tert-butylphenyl)-1,3,4-oxadiazol-2-yl]benzene, 3-(4-biphenylyl)-4-phenyl-5-(4-tert-butylphenyl)-1,2,4-triazole (abbreviated expression: TAZ), bathophenanthoroline, bathocuproine (abbreviated expression: BCP), triphenylbisimidazole (BPBI), 2,2′,2″-(1,3,5-Benzenetriyl)tris[1-phenyl-1H-benzimidazole] (abbreviated expression: TPBI), 3,3′-[5′-[4-(3-Pyridinyl)phenyl][1,1′:3′,1″-terphenyl]-4,4″-diyl]bispyridine (abbreviated expression: TPyTPB), 4,4′-[5′-[3-(4-Pyridinyl)phenyl][1,1′:3′,1″-terphenyl]-3,3″-diyl]bispyridine (abbreviated expression: m4TPyTPB), 3,3′-[5′-[3-(3-Pyridinyl)phenyl][1,1′:3′,1″-terphenyl]-3,3″-diyl]bispyridine (abbreviated expression: mTPyTPB), 2,2′-[5′-[3-(2-Pyridinyl)phenyl][1,1′:3′,1″-terphenyl]-3,3″-diyl]bispyridine (abbreviated expression: m2TPyTPB), and 3-[4-[Bis(2,4,6-trimethylphenyl)boryl]-3,5-dimethylphenyl]pyridin (abbreviated expression: Py211B) can be used. Of these, TPBI, TPyTPB, m4TPyTPB, mTPyTPB, m2TPyTPB and Py211B may be used more preferably.

The materials described here are the materials having an electron mobility of not less than 10⁻⁶ cm²/Vs. It should be noted that the materials other than those described above may be used as an electron transporting layer, as long as the materials have an electron transport property higher than the hole transport property. In addition, the electron transporting layer may not only be a single layer, but also be a layer in which two or more layers composed of the materials described above are laminated. In the case where the film thickness of the electron transporting layer is too thin, an effect of enhancing the electron injection efficiency is not realized. On the other hand, in the case of being too thick, the voltage applied to the electron transporting layer increases and the driving voltage as an entire element increases, and thereby the power supply efficiency is lowered, which is not preferable. Therefore, the film thickness of the electron transporting layer satisfying these conditions is preferably in the range of 0.5 nm to 50 nm, and more preferably in the range of 1 nm to 10 nm, as a specific example.

As a method for forming the electron transporting layer, by a resistance heating method using a vacuum deposition device which is generally used, a deposition method in a vacuum state may be used.

The recessed portion 16 is provided with the light emitting portion 17 applied to the inside thereof, and is provided for extracting the light from the light emitting portion 17. In the exemplary embodiment, the recessed portion 16 is formed by penetrating the anode layer 12 as the first electrode layer and the first low refractive index layer 13. By providing the recessed portion 16 as described above, the light emitted from the light emitting portion 17 is transmitted within the recessed portion 16, and the light can be extracted in both directions which are the substrate 11 side and the cathode layer 14 side. Here, since the recessed portion 16 is formed so as to penetrate the anode layer 12 and the first low refractive index layer 13, it is possible to extract the light even when the anode layer 12 serving as the first electrode layer and the cathode layer 14 serving as the second electrode layer are made of an opaque material.

Here, the shape of the recessed portion 16 is not particularly limited. For easily controlling the shape thereof, it is preferable that the shape of the recessed portion 16 is a cylindrical shape or a trench shape being parallel to the other recessed portions 16 each other, for example. Note that the cylindrical shape in the exemplary embodiment is not necessary to be strictly a cylindrical shape, and it includes a so-called cylinder-like shape meaning that the shape is about a cylinder.

In the electroluminescent element 10 of the exemplary embodiment, if the distance between the recessed portions 16 is set to be small in a case where light is strongly emitted at the recessed portions 16, an emission intensity is set to be large since the number of the recessed portions 16 per unit area is increased. Further, the light emitting portion 17 tends to emit light in the vicinity of the anode layer 12 and the cathode layer 14. In other words, the central part of the recessed portion 16 is likely to be a non light-emitting area, and if the non light-emitting area is large, the electroluminescent element 10 is difficult to emit light with high brightness. Therefore, if the width of the recessed portion 16 is set to be small, the emission intensity is easy to be set large since the non light-emitting area at the central part of the recessed portion 16 is decreased. Specifically, the recessed portion 16 preferably has a width (W) of not more than 10 μm, more preferably not more than 2 μm, and further preferably not more than 1 μm. Note that, “the width of the recessed portion 16” indicates the distance (shortest distance) from one end of the recessed portion 16 to the other end thereof on the shorter axis. In addition, the distance (shortest distance) between the adjacent recessed portions 16 on the shorter axis may be short for the same reason.

The light emitting portion 17 is made of a light-emitting material that emits light by application of voltage and current supply, and is formed by applying the material so as to be in contact with an inner surface of the recessed portion 16. In the light emitting portion 17, holes injected from the anode layer 12 and the electrons injected from the cathode layer 14 are recombined, and light emission occurs. In the exemplary embodiment, the recessed portion 16 is filled with the material of the light emitting portion 17, as mentioned above.

As the material of the light emitting portion 17, either an organic material or an inorganic material may be used. In this case, the electroluminescent element 10 using an organic material is served as an organic electroluminescent element.

In a case where an organic material is used as the light-emitting material, either low-molecular compound or high-molecular compound may be used. Specific examples may include light-emitting low-molecular compound and light-emitting high-molecular compound described in Oyo Butsuri (Applied Physics), Vol. 70, No. 12, pages 1419-1425 (2001) written by Yutaka Ohmori.

However, in the exemplary embodiment, a material may have an excellent coating property. In other words, in the structure of the electroluminescent element 10 in the exemplary embodiment, for stable light emission of the light emitting portion 17 in the recessed portion 16, the light emitting portion 17 may be uniformly in contact with the inner surface of the recessed portion 16 to be formed in a uniform thickness, that is, a coverage property thereof may be improved. If the light emitting portion 17 is formed without using a material having an excellent coating property, the light emitting portion 17 is not uniformly in contact with the recessed portion 16, or the inner surface of the recessed portion 16 tend to be formed in a non-uniform thickness. Thereby, unevenness of brightness of light output from the recessed portion 16 is easily caused.

Further, in order to form the light emitting portion 17 uniformly in the recessed portion 16, a coating method is preferably adopted. In other words, in the coating method, since it is easy to fill light-emitting material solution including a light-emitting material in the recessed portion 16, formation with high coverage property can be achieved even on a surface having asperity. In the coating method, materials having mainly a weight average molecular weight of 1,000 to 2,000,000 are preferably used to improve the coating property. Moreover, it is possible to add additives for improving the coating property such as a leveling agent and a defoaming agent, or to add a binder resin having low charge trapping capability.

Specifically, examples of material having an excellent coating property include: arylamine compound having a predetermined structure with a molecular weight of 1,500 or more to 6,000 or less disclosed in Japanese Patent Application Laid Open Publication No. 2007-86639; and a predetermined high molecular phosphor disclosed in Japanese Patent Application Laid Open Publication No. 2000-034476.

Among the materials having the excellent coating property, a light-emitting high-molecular compound may be preferable in terms of simplification of manufacturing process of the electroluminescent element 10, and a phosphorescent light-emitting compound may be preferable in terms of high light-emitting efficiency. Accordingly, a phosphorescent light-emitting high-molecular compound is particularly preferable. Note that, it is possible to mix plural materials or to add a low molecular light-emitting material (for example, molecular weight of not more than 1,000) within a scope which does not impair the coating property. On this occasion, an amount of adding the low molecular light-emitting material is preferably not more than 30 wt %.

Further, the light-emitting high-molecular compound may be classified into a conjugated light-emitting high-molecular compound and a non-conjugated light-emitting high-molecular compound; however, among these, the non-conjugated light-emitting high-molecular compound may be preferable.

From the aforementioned reasons, as the light-emitting material used in the exemplary embodiment, a phosphorescent light-emitting non-conjugated high-molecular compound (a light-emitting material which is a phosphorescent light-emitting polymer and also a non-conjugated light-emitting high-molecular compound) is especially preferable.

The light emitting portion 17 of the electroluminescent element 10 according to the present invention preferably include at least the phosphorescent light-emitting polymer (phosphorescent light-emitting organic material) in which one molecule contains a phosphorescent light-emitting unit that emits phosphorescent light and a carrier transporting unit that transports a carrier. The phosphorescent light-emitting polymer is obtained by copolymerizing a phosphorescent light-emitting compound having a polymerizing substituent and a carrier-transporting compound having a polymerizing substituent. The phosphorescent light-emitting compound is a metal complex containing a metallic element selected from iridium (Ir), platinum (Pt) and gold (Au), and especially, an iridium complex is preferable.

Specific examples of the polymerizing substituent in the phosphorescent light-emitting compound include a vinyl group, an acrylate group, a methacrylate group, an urethane(meth)acrylate group such as a methacryloyl oxyethyl carbamate group, a styryl group and a derivative thereof, and a vinyl amide group and a derivative thereof. Among these, a vinyl group, a methacrylate group, and a styryl group and a derivative thereof are particularly preferable. These substituents may bind to a metal complex via an organic group that has 1 to 20 carbons and may have a hetero atom.

Specific examples of the carrier-transporting compound having a polymerizing substituent include a compound in which one or more hydrogen atoms in an organic compound having any one or both of a hole transport property and an electron transport property are substituted by polymerizing substituents.

Although the polymerizing substituent in the carrier-transporting compounds is a vinyl group, compounds in which the vinyl group is substituted by another polymerizing substituent such as an acrylate group, a methacrylate group, an urethane(meth)acrylate group such as a methacryloyl oxyethyl carbamate group, a styryl group and a derivative thereof, and an vinyl amide group and a derivative thereof may be accepted. Further, these polymerizing substituents may bind thereto via an organic group that has 1 to 20 carbons and may have a hetero atom.

As a polymerization procedure for polymerizing a phosphorescent light-emitting compound having a polymerizing substituent and a carrier-transporting compound having a polymerizing substituent, any of a radical polymerization, a cationic polymerization, an anionic polymerization, and an addition polymerization is acceptable. However, a radical polymerization is preferable. A molecular weight of the polymer is preferably, as a weight-average molecular weight, 1,000 to 2,000,000, and more preferably 5,000 to 1,000,000. The molecular weight in the exemplary embodiment is a polystyrene equivalent molecular weight measured by a gel permeation chromatography (GPC).

The phosphorescent light-emitting polymer may be made by copolymerizing a phosphorescent light-emitting compound and a carrier-transporting compound, or a phosphorescent light-emitting compound and two or more kinds of carrier-transporting compounds. Alternatively, it may be made by copolymerizing two or more kinds of phosphorescent light-emitting compounds and a carrier-transporting compound.

As a monomer sequence of the phosphorescent light-emitting polymer, any of a random copolymer, a block copolymer, and an alternate copolymer is acceptable. If the number of repeating units of a structure of the phosphorescent light-emitting compound is denoted by m, and the number of repeating units of a structure of the carrier-transporting compound is denoted by n (m and n are integers not less than 1), a proportion of the number of the repeating units of the structure of the phosphorescent light-emitting compound to the total number of the repeating units, that is, the value of m/(m+n) is preferably in a range of 0.001 to 0.5, and more preferably in a range of 0.001 to 0.2.

More specific examples and synthesis methods of the phosphorescent light-emitting polymer are disclosed in, for example, Japanese Patent Application Laid Open Publications No. 2003-342325, No. 2003-119179, No. 2003-113246, No. 2003-206320, No. 2003-147021, No. 2003-171391, No. 2004-346312, No. 2005-97589, and No. 2007-305734.

The light emitting portion 17 of the electroluminescent element 10 according to the exemplary embodiment preferably includes the aforementioned phosphorescent light-emitting compound, and may include a hole-transporting compound or an electron-transporting compound in order to supplement the carrier transport property of the light emitting portion 17. Examples of the hole-transporting compound used for this purpose include low molecular triphenylamine derivatives such as: TPD (N,N′-dimethyl-N,N′-(3-methylphenyl)-1,1′-biphenyl-4,4′diamine); α-NPD (4,4′-bis[N-(1-naphthyl)-N-phenylamino]biphenyl); and m-MTDATA (4,4′,4″-tris(3-methylphenylphenylamino)triphenylamine). In addition, examples also include: polyvinylcarbazole; triphenylamine derivative-based high-molecular compound polymerized by introducing a polymerizable functional group; a polymer compound having a triphenylamine skeleton disclosed in Japanese Patent Application Laid Open Publication No. 8-157575; polyparaphenylenevinylene; and polydialkylfluorene. Further, examples of the electron-transporting compound include low molecular materials such as: a quinolinol derivative metal complex such as trisquinolinolato aluminum (Alq3); an oxadiazole derivative; a triazole derivative; an imidazole derivative; a triazine derivative; and a triarylborane derivative. The examples further include known electron-transporting compounds such as the aforementioned low-molecular electron-transporting compound polymerized by introducing the polymerizable functional group, for instance, polyPBD disclosed in Japanese Patent Application Laid Open Publication No. 10-1665.

Even in a case of using a light-emitting low-molecular compound instead of the aforementioned light-emitting polymer compound as a light-emitting material used for the light emitting portion 17, the light emitting portion 17 can be formed. Further, it is also possible to add the aforementioned light-emitting polymer compound as a light-emitting material, and to add the hole-transporting compounds or the electron-transporting compounds.

Specific examples of the hole-transporting compounds in this case include, for example, TPD, α-NPD, m-MTDATA, phthalocyanine complex, DTDPFL, spiro-TPD, TPAC, PDA and the like disclosed in Japanese Patent Application Laid Open Publication No. 2006-76901.

Specific examples of the electron-transporting compound include, for example, BPhen, BCP, OXD-7 and TAZ disclosed in Japanese Patent Application Laid Open Publication No. 2006-76901.

Further, for example, a compound having a bipolar molecular structure having the hole transport property and the electron transport property in one molecule, which is disclosed in Japanese Patent Application Laid Open Publication No. 2006-273792, is also usable.

In the electroluminescent element 10 in the exemplary embodiment, an inorganic material is usable for a light-emitting body as mentioned above. The electroluminescent element 10 using an inorganic material is served as an inorganic electroluminescent element. As an inorganic material, for example, an inorganic phosphor may be used. Specific examples of this inorganic phosphor, a configuration of the electroluminescent element and a manufacturing method thereof are disclosed in Japanese Patent Application Laid Open Publication No. 2008-251531 as a known technique, for example.

The second low refractive index layer 19 is a layer for making more light entered into the substrate 11 by providing it. In the exemplary embodiment, the refractive index of the second low refractive index layer 19 is preferably lower than that of the light emitting portion 17.

In the case where the second low refractive index layer 19 is provided, compared to the case where it is not provided, the light extraction efficiency is improved. In other words, if the second low refractive index layer 19 is not provided and the part is filled with the light-emitting material, the light emitted from the light emitting portion 17 is easy to be attenuated since the light transmission of the light-emitting material is lower than that of the second low refractive index layer 19. On the other hand, by providing the second low refractive index layer 19, as shown in FIG. 2, a light L2 that is emitted from the light emitting portion 17 and passes through the second low refractive index layer 19 is less attenuated and reaches the substrate 11. As a result, the light emitted from the light emitting portion 17 can be extracted more at a substrate 11 side, thereby the light extraction efficiency is improved. In particular, the light emitted from the light emitting portion 17 is, after entering into the second low refractive index layer 19, reflected at a boundary surface between the second low refractive index layer 19 and the substrate 11 with a certain rate according to the incident angle. Therefore, the light repeats to be reflected for several times at the boundary surface until being extracted from the substrate 11. This indicates that there exists a component having a very long light path, and an amount of the extracted light largely varies even if the difference between the light transmission of the light-emitting material and that of the second low refractive index layer 19 is extremely small. Thus, the light transmission is preferably higher as much as possible. Note that the light emitting portion 17 is provided to the entire inner surface of the recessed portion 16, the light emitting portion 17 mainly emits light at a position adjacent to the first low refractive index layer 13 and hardly emits light at a part where the second low refractive index layer 19 is provided. Therefore, loss of light emission which occurs due to providing the second low refractive index layer 19 is little. That is, when the second low refractive index layer 19 is provided, more light can reach the substrate 11, and thereby more light can be extracted from the substrate 11 side.

In addition, a part where the recessed portion 16 is provided in the exemplary embodiment, the anode layer 12 does not exist. Therefore, at this part, such an occasion does not occur that the intensity of the light entering into the anode layer 12 is largely attenuated due to the low light transmission of the anode layer 12. Furthermore, such an occasion does not occur that the light is confined within the anode layer 12 due to the total reflection arising from the high refractive index of the anode layer 12. Therefore, also in this point, from the view point of the light extraction efficiency, the electroluminescent element 10 in the exemplary embodiment is favorable.

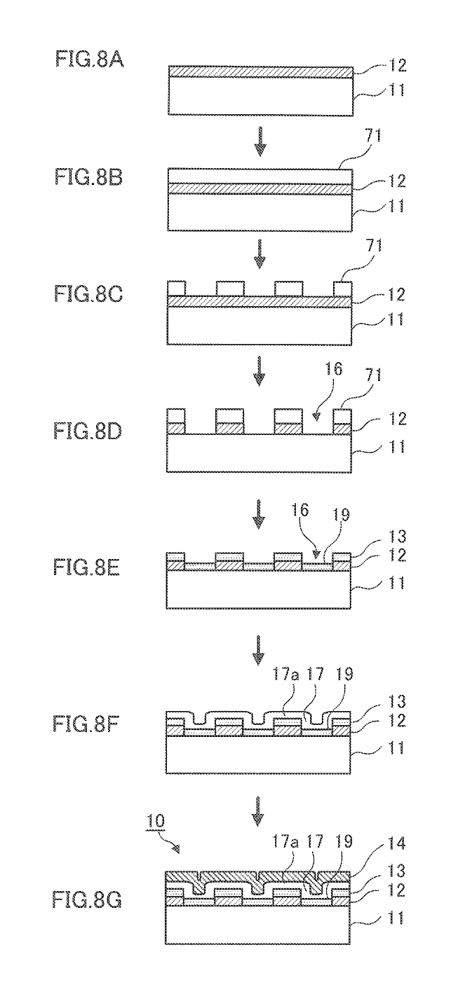

In the exemplary embodiment, the second low refractive index layer 19 and the first low refractive index layer 13 may be formed of different materials or be formed of the same material. However, by forming them with the same material, as will be described later in FIG. 8E, the second low refractive index later 19 and the first low refractive index layer 13 can be formed in one forming process, and thereby it becomes more easy to produce the electroluminescent element 10.

In this case, if the first low refractive index layer 13 has insulation properties, the second low refractive index layer 19 also has insulation properties. Therefore, it is required that the second low refractive index layer 19 is formed so that the thickness thereof is thinner than that of the anode layer 12 and the side surface of the light emitting portion 17 is in contact with a side surface 12a of the anode layer 12. Accordingly, the anode layer 12 and the light emitting portion 17 are electrically conducted, and current can be flowed from the anode layer 12 to the light emitting portion 17.

The electroluminescent element 10 that has been described above in detail is not limited to the electroluminescent element in which the light emitting portion 17 spreads and is formed not only in the inside of the recessed portion 16 but also on the upper surface of the first low refractive index layer 13.

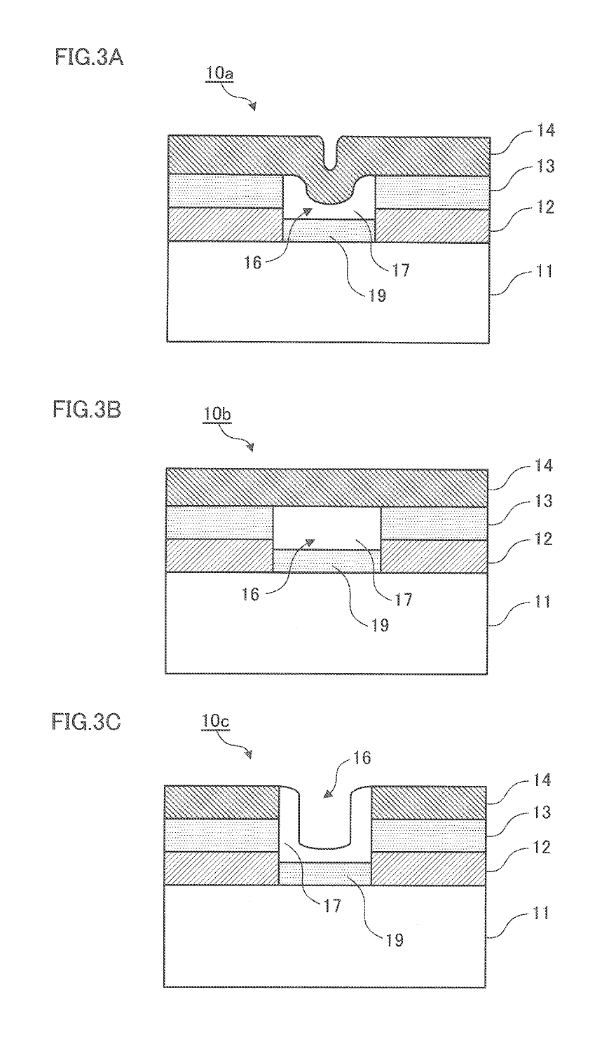

FIGS. 3A to 3C illustrate and explain other modes of the light emitting portion 17 in the electroluminescent element to which the exemplary embodiment is applied. These are the specific second to fourth examples of the electroluminescent element to which the exemplary embodiment is applied.

An electroluminescent element 10a in FIG. 3A shows a case where the light emitting portion 17 is formed inside the recessed portion 16 but the light emitting portion 17 is not formed on the upper surface of the first low refractive index layer 13.

Further, an electroluminescent element 10b in FIG. 3B shows a case where the light emitting portion 17 is not formed on the upper surface of the first low refractive index layer 13, and all of the recessed portion 16 is filled with the light emitting portion 17. By this configuration, the cathode layer 14 is formed in a planar state.

Furthermore, an electroluminescent element 10c in FIG. 3C shows a case where the recessed portion 16 is provided also in the cathode layer 14, and the light emitting portion 17 is formed so that the light emitting portion 17 is located along the inside of the recessed portion 16. In this configuration, only part of the recessed portion 16 is filled with the light emitting portion 17. Further, since the recessed portion 16 is formed also in the cathode layer 14, even if the cathode layer 14 is made of an opaque material, light is extracted not only from the substrate 11 side but also from the cathode layer 14 side.

Also in these electroluminescent elements 10a, 10b and 10c, by providing the first low refractive index layer 13 and the second low refractive index layer 19, light extraction efficiency is improved.

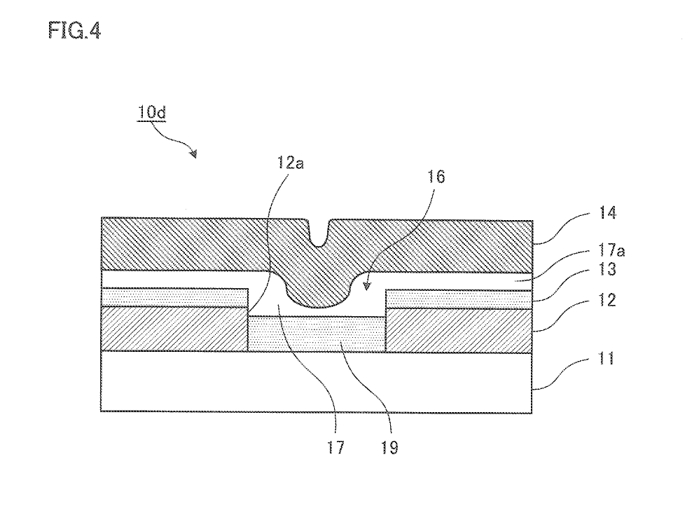

FIG. 4 is a partial cross-sectional view illustrating a fifth specific example of an electroluminescent element to which the exemplary embodiment is applied.

In an electroluminescent element 10d in FIG. 4, the positional relationship of the substrate 11, the anode layer 12, the first low refractive index layer 13, the cathode layer 14, the recessed portion 16, the light emitting portion 17 and the second low refractive index layer 19 is similar to that of the electroluminescent element 10 shown in FIG. 1. However, the electroluminescent element 10d is produced so that the thickness of the first low refractive index layer 13 is thinner than that of the second low refractive index layer 19. By this configuration, the step between the first low refractive index layer 13 and the second low refractive index layer 19 can be made smaller. Accordingly, coverage property is improved when the light emitting portion 17 and the extension portion 17a are formed by coating the light-emitting material. Therefore, the light emitting portion 17 and the extension portion 17a are formed more stably.

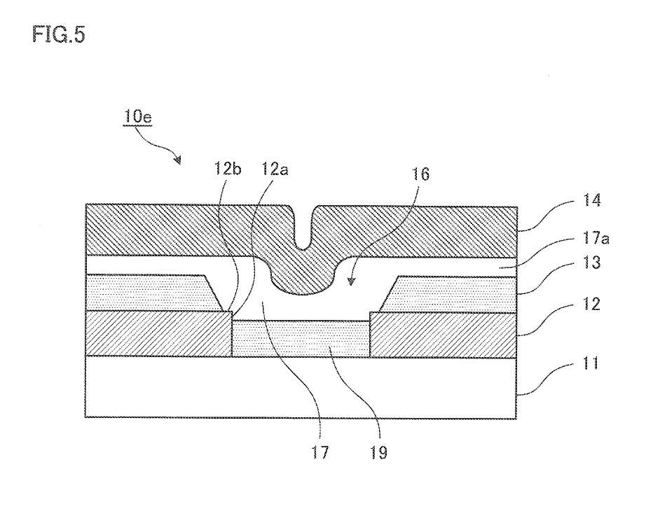

FIG. 5 is a partial cross-sectional view illustrating a sixth specific example of an electroluminescent element to which the exemplary embodiment is applied.

In an electroluminescent element 10e in FIG. 5, the positional relationship of the substrate 11, the anode layer 12, the first low refractive index layer 13, the cathode layer 14, the recessed portion 16, the light emitting portion 17 and the second low refractive index layer 19 is similar to that of the electroluminescent element 10 shown in FIG. 1. However, the difference is the following point that the cross-sectional shape of the first low refractive index layer 13 is a tapered shape at an end portion thereof to contact the recessed portion 16. By this configuration, a volume of the light emitting portion 17 emitting light between the anode layer 12 and the cathode layer 14 is increased, thus the light emitted from the light emitting portion 17 is likely to be increased.

Additionally, the electroluminescent element 10e is further different, with respect to the electroluminescent element 10, in that the light emitting portion 17 is in contact with an upper surface 12b of the anode layer 12. By this configuration, even if the volume of the light emitting portion 17 is increased, sufficient current is applied from the anode layer 12.

It should be noted that, even if the end portion of the first low refractive index layer 13 is formed as in the exemplary embodiment, the light emitted from the light emitting portion 17 is refracted at an angle near the normal direction when entering into the first low refractive index layer 13.

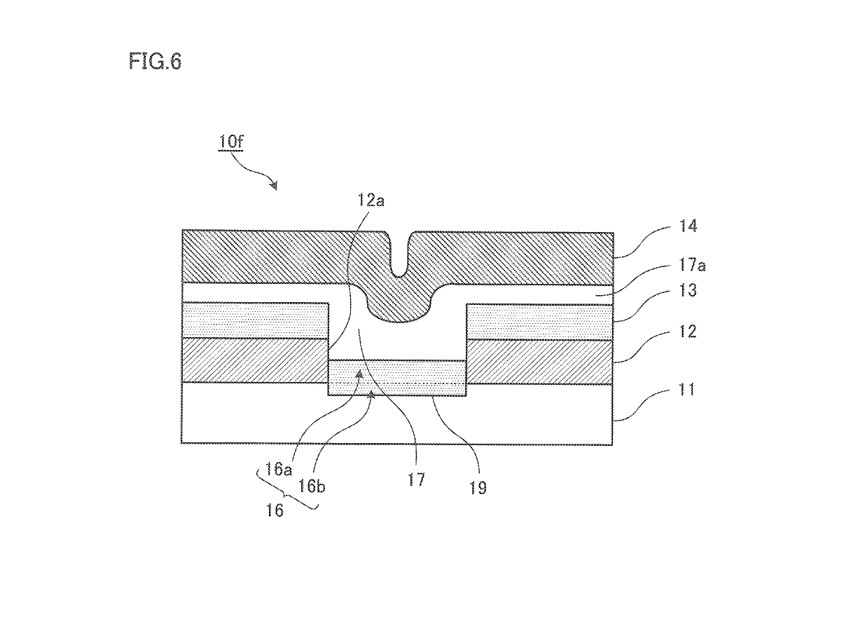

FIG. 6 is a partial cross-sectional view illustrating a seventh specific example of an electroluminescent element to which the exemplary embodiment is applied.

In an electroluminescent element 10f in FIG. 6, the positional relationship of the substrate 11, the anode layer 12, the first low refractive index layer 13, the cathode layer 14, the recessed portion 16, the light emitting portion 17 and the second low refractive index layer 19 is similar to that of the electroluminescent element 10 shown in FIG. 1. However, the recessed portion 16 includes; a penetrating part 16a that is formed to penetrate the anode layer 12 and the first low refractive index layer 13; and a bored part 16b that is formed in the substrate 11. By forming the bored part 16b like this, the thickness of the second low refractive index layer 19 is set to be large by the depth of the bored part 16b. That is, by adjusting the depth of the bored part 16b, the thickness of the second low refractive index layer 19 can be adjusted.

Note that, in the electroluminescent elements 10 and 10a to 10f having been described above in detail, description has been given for a case where the anode layer 12 is formed on the lower side and the cathode layer 14 is formed on the upper side while the first low refractive index layer 13 is sandwiched therebetween so as to be opposed thereto if the substrate 11 side is set as a lower side, as an example. However, the structure is not limited to the above, and a structure in which the anode layer 12 and the cathode layer 14 are switched to each other may be accepted. In other words, a configuration where the cathode layer 14 is formed on the lower side and the anode layer 12 is formed on the upper side while the first low refractive index layer 13 is sandwiched therebetween so as to be opposed thereto if the substrate 11 side is set as a lower side is also accepted.

In addition, in the specific examples described above, the first low refractive index layer 13 is formed of a material having insulating properties, however, the configuration is not limited to this and the first low refractive index layer 13 may be formed of a material having conductive properties. However, in this case, it is required to additionally provide an insulating layer between the anode layer 12 and the cathode layer 14. The insulating layer may be provided to an upper portion of the first low refractive index layer 13 or a lower portion of the first low refractive index layer 13.

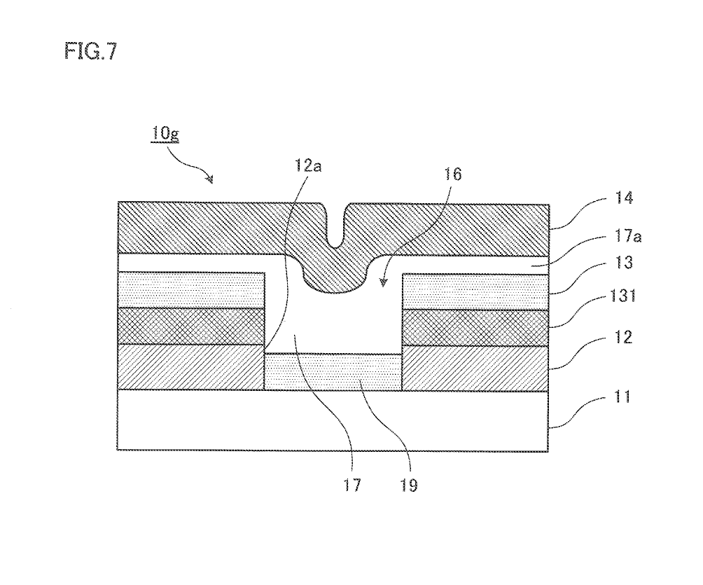

FIG. 7 is a partial cross-sectional view illustrating an eighth specific example of an electroluminescent element to which the exemplary embodiment is applied.

In an electroluminescent element 10g in FIG. 7, compared to the electroluminescent element 10 shown in FIG. 1, an insulating layer 131 is formed between the anode layer 12 and the first low refractive index layer 13. By this configuration, even if a material having conductive properties is used for the first low refractive index layer 13, insulating properties between the anode layer 12 and the cathode layer 14 are kept by the insulation layer 131. Accordingly, the light emitting portion 17 emits light with applying current to the light emitting portion 17.

### (Manufacturing Method of Electroluminescent Element)

Next, description will be given for a manufacturing method of the electroluminescent element to which the exemplary embodiment is applied, while the electroluminescent element 10 described with FIG. 1 is taken as an example.

FIGS. 8A to 8G are diagrams for illustrating the manufacturing method of the electroluminescent element 10 to which the exemplary embodiment is applied.

First, on the substrate 11, the anode layer 12 as a first electrode layer is stacked (FIG. 8A: first electrode layer forming process). In the exemplary embodiment, a glass substrate is used as the substrate 11. Further, ITO is used as a material for forming the anode layer 12.

For forming the anode layer 12 on the substrate 11, a resistance heating deposition method, an electron beam deposition method, a sputtering method, an ion plating method, a CVD method or the like may be used. Alternatively, if a film-forming method, that is, a method for applying a suitable material solved in a solvent to the substrate 11 and then drying the same is applicable, the anode layer 12 can be formed by a spin coating method, a dip coating method, an ink-jet printing method, a printing method, a spray-coating method and a dispenser-printing method or the like.

It should be noted that this first electrode layer forming process can be omitted by using a so-called substrate with electrode in which ITO as the anode layer 12 has already been formed on the substrate 11.

Next, the recessed portion 16 is formed so as to penetrate the anode layer 12. For forming the recessed portion 16, a method using lithography may be used, for example. To form the recessed portion 16, first, a resist solution is applied on the anode layer 12 and then an excess resist solution is removed by spin coating or the like to form a resist layer 71 (FIG. 8B).

Thereafter, the resist layer 71 is covered with a mask (not shown), in which a predetermined pattern for forming the recessed portion 16 is rendered, and is exposed with ultraviolet light (UV), an electron beam (EB) or the like. Then, the predetermined pattern corresponding to the recessed portion 16 is exposed onto the resist layer 71. Thereafter, light exposure portions of the resist layer 71 are removed by use of a developing solution, exposed pattern portions of the resist layer 71 are removed (FIG. 8C). By this process, the surface of the anode layer 12 is exposed so as to correspond to the exposed pattern portions.

Then, by using the remaining resist layer 71 as a mask, exposed portions of the anode layer 12 are removed by etching (FIG. 8D). Either dry etching or wet etching may be used as the etching. Further, by combining isotropic etching and anisotropic etching at this time, the shape of the recessed portion 16 can be controlled. Reactive ion etching (RIE) or inductive coupling plasma etching is used as the dry etching, and a method of immersion in diluted hydrochloric acid, diluted sulfuric acid, or the like is used as the wet etching. By the etching, the surface of the substrate 11 is exposed so as to correspond to the aforementioned pattern. It should be noted that the process explained in FIGS. 8B to 8D is considered to be a recessed portion forming process in which the recessed portion 16 is formed in the anode layer 12.

Next, the residual resist layer 71 is removed by using a resist removing solution, and the first low refractive index layer 13 and the second low refractive index layer 19 are formed (FIG. 8E: low refractive index layer forming process). In the exemplary embodiment, silicon dioxide (SiO₂) is used as a material for forming the first low refractive index layer 13. Similarly to the formation of the anode layer 12, a resistance heating deposition method, an electron beam deposition method, a sputtering method, an ion plating method, a CVD method or the like may be used for forming the first low refractive index layer 13. By using these methods, the first low refractive index layer 13 and the second low refractive index layer 19 are formed together. The first low refractive index layer 13 is formed to be laminated on the anode layer 12, and the second low refractive index layer 19 is formed at a bottom portion of the recessed portion 16. It should be noted that it is possible to separately form the first low refractive index layer 13 and the second low refractive index layer 19. However, by forming the first low refractive index layer 13 and the second low refractive index layer 19 which are composed of the same material together as in the exemplary embodiment, it becomes easier to produce the electroluminescent element 10.

Next, the light emitting portion 17 containing the light-emitting material is formed on the first low refractive index layer 13 and the second low refractive index layer 19 (FIG. 8F: light emitting portion forming process). For forming the light emitting portion 17, the above-mentioned coating method described in the explanation on the light emitting portion 17 is used. Specifically, light-emitting material solution in which the light-emitting material for the light emitting portion 17 is dispersed in predetermined solvent such as organic solvent or water is firstly applied. To perform coating, various methods such as a spin coating method, a spray coating method, a dip coating method, an ink-jet method, a slit coating method, a dispenser method and a printing method may be used. After the coating is performed, the light-emitting material solution is dried by heating or vacuuming, and thereby the light-emitting material adheres to the inner surface of the recessed portion 16 to form the light emitting portion 17. At this time, the light emitting portion 17 is formed so as to spread onto the first low refractive index layer 13. By adopting this configuration, manufacture of the electroluminescent element 10 is easier than the case where the light emitting portion 17 is formed only at the inside of the recessed portion 16, since it is not necessary to remove the coating liquid applied on the portions other than the recessed portion 16 after the coating.

Then, the cathode layer 14 as a second electrode layer is formed so as to be stacked on the light emitting portion 17 (FIG. 8G: second electrode layer forming process). A method similar to the method for forming the anode layer 12 is performed to form the cathode layer 14.

By the aforementioned processes, the electroluminescence element 10 is manufactured.

In the manufacturing method of electroluminescent element according to the exemplary embodiment, the recessed portion forming process for forming the recessed portion 16 is provided next to the first electrode layer forming process for forming the anode layer 12. Therefore, the exemplary embodiment has following advantages compared to the case where the first low refractive index layer is formed next to the first electrode layer forming process and the first electrode and the first low refractive index layer are etched to form the recessed portion 16.

(1) If the two layers of the anode layer 12 and the first low refractive index layer 13 are etched, there are some cases in which the resist layer 71 is lost in the process by etching, and processing of the predetermined pattern is not achieved. However, such a situation hardly occurs in the exemplary embodiment.

(2) If the two layers of the anode layer 12 and the first low refractive index layer 13 are etched, the material forming the first low refractive index layer 13 is limited to the material that is able to be patterned in the recessed portion forming process. However, there is no such a limitation in the exemplary embodiment.

(3) If the two layers of the anode layer 12 and the first low refractive index layer 13 are etched, the first low refractive index layer 13 is limited to the one whose property does not change in the recessed portion forming process. However, there is no such a limitation in the exemplary embodiment.

For manufacturing the electroluminescent element 10d shown in FIG. 4, an anisotropic etching may be performed after the low refractive index layer forming process shown in FIG. 8E described above. By anisotropic etching, the first low refractive index layer 13 is etched prior to the second low refractive index layer 19, thus the thickness of the first low refractive index layer 13 is made thinner than that of the second low refractive index layer 19. This process may be considered as a film thinning process in which the thickness of the second low refractive index layer 19 is made small between the low refractive index layer forming process and the light emitting portion forming process.

For manufacturing the electroluminescent element 10e shown in FIG. 5, an isotropic etching may be performed after the low refractive index layer forming process shown in FIG. 8E described above. That is, since the end portion of the first low refractive index layer 13 is etched isotropicaly, the end portion of the first low refractive index layer 13 is removed to be a tapered shape. This process may be considered as an electrode exposure process in which a part of the first electrode layer 13 is exposed between the film thinning process and the light emitting portion forming process.

For manufacturing the electroluminescent element 10f shown in FIG. 6, a part of the substrate 11 is further removed by boring after a process of removing the anode layer 12 as shown in FIG. 8E described above. By this performance, the bored part 16b is formed. For removing a part of the substrate 11, methods using etching similar to those explained in FIG. 8E can be employed.

Furthermore, for manufacturing the electroluminescent element 10g shown in FIG. 7, firstly the insulating layer 131 composed of the material having insulating properties is formed after the first electrode layer forming process for forming the anode layer 12 shown in FIG. 8A. Then, the recessed portion forming process illustrated in FIGS. 8B to 8D is performed. By the etching performed in these processes, the recessed portion 16 is formed to penetrate the anode layer 12 and the insulating layer 131. The insulating layer 131 can be formed with the method similar to that of the anode layer 12.

Further, after the sequence of these processes, a protective layer or a protective cover (not shown) for stably using the electroluminescent element 10 for long periods and protecting the electroluminescent element 10 from outside may be mounted. As the protective layer, polymer compounds, metal oxides, metal fluorides, metal borides, or silicon compounds such as silicon nitrides and silicon oxides may be used. A lamination thereof may also be used. As the protective cover, glass plates, plastic plates with a surface treated with low hydraulic permeability, or metals may be used. The protective cover may be bonded to the substrate 11 by using a thermosetting resin or a photo-curable resin to be sealed. At this time, spacers may be used so that predetermined spaces are maintained, thus the prevention of scratches on the electroluminescent element 10 is facilitated. Filling the spaces with inert gases such as nitrogen, argon and helium prevents the oxidation of the cathode layer 14 on the upper side. Especially, in a case of using helium, high thermal conductivity thereof enables heat generated from the electroluminescent element 10 upon application of voltage to be effectively transmitted to the protective cover. In addition, by putting desiccants such as barium oxide in the spaces, the electroluminescent element 10 is easily prevented from being damaged by moisture absorbed in the sequence of the aforementioned manufacturing processes.

### (Display Device)

Next, description will be given for a display device having the aforementioned electroluminescent element described in detail.

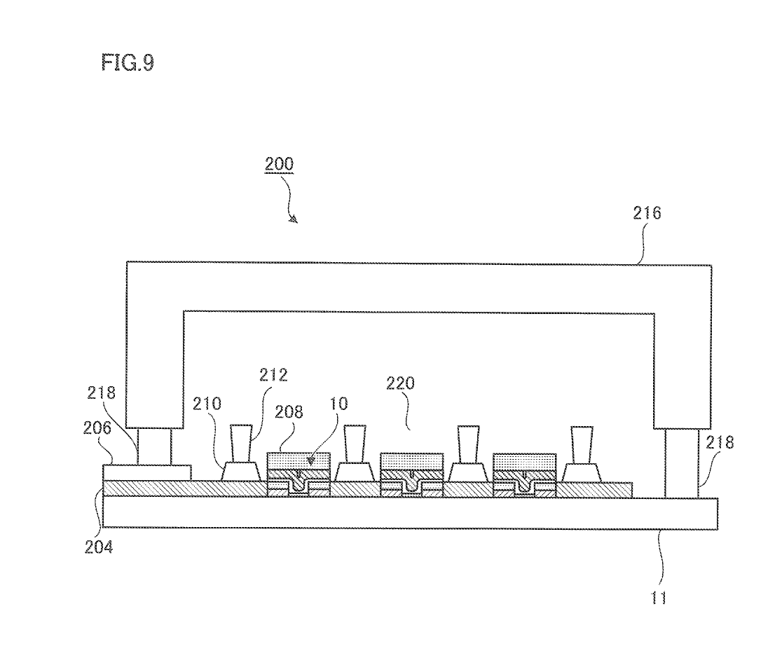

FIG. 9 is a diagram for illustrating an example of a display device using the electroluminescent element according to the exemplary embodiment.

A display device 200 shown in FIG. 9 is a so-called passive matrix display device, and is provided with an anode wiring 204, an auxiliary anode wiring 206, a cathode wiring 208, an insulating film 210, a cathode partition 212, a shield plate 216, and a sealant 218, in addition to the electroluminescent element 10.

In the exemplary embodiment, plural anode wirings 204 are formed on the substrate 11 of the electroluminescent element 10. The anode wirings 204 are arranged in parallel with certain intervals. The anode wiring 204 is configured with a transparent conductive film, and is made of, for example, ITO (indium tin oxide). The thickness of the anode wiring 204 may be set to, for example, 100 nm to 150 nm. The auxiliary anode wiring 206 is formed on an end portion of each of the anode wirings 204. The auxiliary anode wiring 206 is electrically connected to the anode wirings 204. With such a configuration, the auxiliary anode wiring 206 functions as a terminal for connection to an external wiring on the end portion side of the substrate 11, and accordingly, a current is supplied from a not-shown drive circuit provided outside to the anode wirings 204 through the auxiliary anode wiring 206. The auxiliary anode wiring 206 may be configured with, for example, a metal film having a thickness of 500 nm to 600 nm.

Plural cathode wirings 208 are also provided on the electroluminescent element 10. The plural cathode wirings 208 are arranged in parallel with each other, and each intersecting the anode wirings 204. Aluminum or aluminum alloy may be used for the cathode wiring 208. The thickness of the cathode wirings 208 is, for example, 100 nm to 150 nm. Further, similar to the auxiliary anode wiring 206 for the anode wirings 204, a not-shown auxiliary cathode wiring is provided on an end portion of each of the cathode wirings 208, and is electrically connected to the cathode wirings 208. Consequently, a current is capable of flowing between the cathode wirings 208 and the auxiliary cathode wiring.

Further, on the substrate 11, the insulating film 210 is formed to cover the anode wirings 204. An opening 220 having a rectangular shape is provided in the insulating film 210 to expose a part of the anode wiring 204. Plural openings 220 are arranged in a matrix on the anode wirings 204. The electroluminescent elements 10 are provided at the openings 220 between the anode wirings 204 and the cathode wirings 208. In other words, each opening 220 becomes a pixel. Accordingly, a display region is formed corresponding to the openings 220. Here, the thickness of the insulating film 210 may be set to, for example, 200 nm to 300 nm, and the size of the opening 220 may be set to, for example, 300 μm×300 μm.

As mentioned above, the electroluminescent elements 10 are located between the anode wirings 204 and the cathode wirings 208 at the openings 220. In this case, the anode layers 12 of the electroluminescent elements 10 are in contact with the anode wirings 204, and the cathode layers 14 are in contact with the cathode wirings 208. The thickness of the electroluminescent elements 10 is set to, for example, 150 nm to 200 nm.

On the insulating film 210, plural cathode partitions 212 are formed along the direction perpendicular to the anode wirings 204. The cathode partitions 212 play a role in spacially separating the plural cathode wirings 208 so that the cathode wirings 208 are not electrically connected to each other. Accordingly, each of the cathode wirings 208 is arranged between the adjacent cathode partitions 212. The size of the cathode partition 212 may be, for example, 2 μm to 3 μm in height and 10 μm in width.

The substrate 11 is bonded to the shield plate 216 with the sealant 218. By this configuration, a space where the electroluminescent element 10 is provided is shielded, and thus the electroluminescent element 10 is prevented from deteriorating due to moisture in the air. As the shield plate 216, for example, a glass substrate having a thickness of 0.7 mm to 1.1 mm may be used.

In the display device 200 with such a configuration, a current is supplied to the electroluminescent elements 10 via the auxiliary anode wirings 206 and the not-shown auxiliary cathode wirings from a not-shown driving device to cause the light emitting portion 17 (refer to FIG. 1) to emit light. Further the light is output from the recessed portions 16 (refer to FIG. 1) to the outside through the substrate 11. By controlling light emission and non-light emission of the electroluminescent elements 10 corresponding to the aforementioned pixels with a controller, images may be displayed on the display device 200.

### (Illuminating Device)

Next, description will be given for an illuminating device using the electroluminescent elements 10.

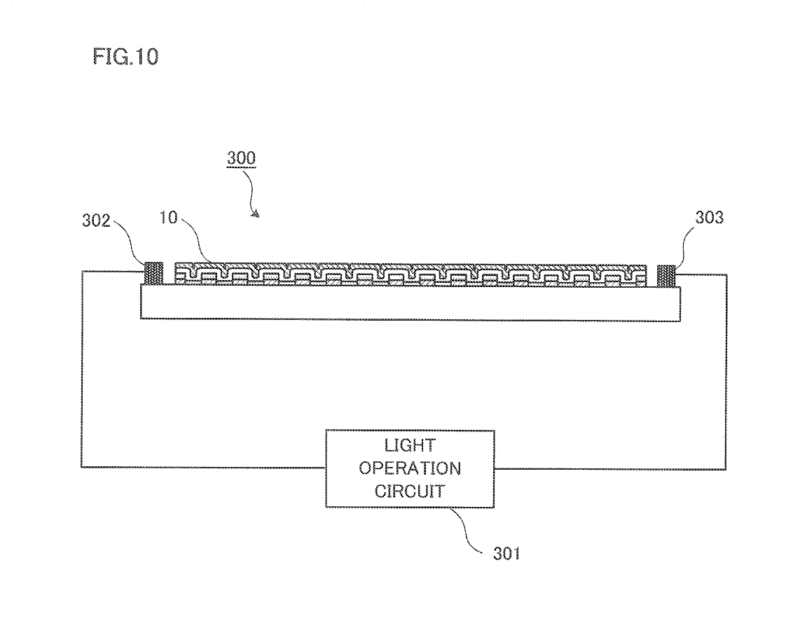

FIG. 10 is a diagram for illustrating an example of an illuminating device having the electroluminescent element according to the exemplary embodiment.

An illuminating device 300 shown in FIG. 10 is configured with: the aforementioned electroluminescent element 10; a terminal 302 that is provided adjacent to the substrate 11 (refer to FIG. 1) of the electroluminescent element 10 and is connected to the anode layer 12 (refer to FIG. 1); a terminal 303 that is provided adjacent to the substrate 11 (refer to FIG. 1) and is connected to the cathode layer 14 (refer to FIG. 1) of the electroluminescent element 10; and a light operation circuit 301 that is connected to the terminals 302 and 303 to drive the electroluminescent element 10.

The light operation circuit 301 has a not-shown DC power supply and a not-shown control circuit inside thereof, and supplies a current between the anode layer 12 and the cathode layer 14 of the electroluminescent element 10 via the terminals 302 and 303. The light operation circuit 301 drives the electroluminescent element 10 to cause the light emitting portion 17 (refer to FIG. 1) to emit light, the light is outputted from the recessed portions 16 to the outside through the substrate 11, and the light is utilized for illumination. The light emitting portion 17 may be configured with the light-emitting material that emits white light, or, it may be possible to provide plural electroluminescent elements 10 using a light-emitting material that radiates each of the green light (G), blue light (B) and red light (R), thus making a synthetic light white. Note that, in the illuminating device 300 according to the exemplary embodiment, when the light emission is performed with small diameter of the recessed portions 16 (refer to FIG. 1) and small intervals between the recessed portions 16, the light emission seems to be surface emitting to the human eyes.

### EXAMPLES

### Example 1

### Preparation of Phosphorescent Light-Emitting Polymer Compound

The aforementioned compounds expressed by the chemical formulas E-2 (iridium complex having a polymerizing substituent), E-54 (hole transporting compound) and E-66 (electron transporting compound) were dissolved in dehydrated toluene with the ratio (mass ratio) of E-2:E-54:E-66=1:4:5, and V-601 (manufactured by Wako Pure Chemical Industries, Ltd.) as a polymeric initiator was further dissolved therein. After freeze pumping operation, vacuum seal was performed, and the resultant solution was stirred for 100 hours at 70 degrees C. for polymerization reaction. After the reaction, the reaction solution was delivered by drops into acetone to cause deposition, and then reprecipitation purification with dehydrated toluene-acetone was repeated three times to purify the phosphorescent light-emitting polymer compound. Here, as each of dehydrated toluene and acetone, solution distilled from high-purity solution manufactured by Wako Pure Chemical Industries, Ltd. was used.

By analyzing the solution after the third reprecipitation purification by high-performance liquid chromatography, it was confirmed that any material absorbing light at regions not less than 400 nm was not detected in the solution. In other words, it means that impurities were hardly contained in the solution, and the phosphorescent light-emitting polymer compound was sufficiently purified. Then, the purified phosphorescent light-emitting polymer compound was vacuum-dried for two days at room temperature. The phosphorescent light-emitting polymer (ELP) obtained by this operation was confirmed to have the purity of over 99.9% by the high-performance liquid chromatography (detection wavelength: 254 nm).

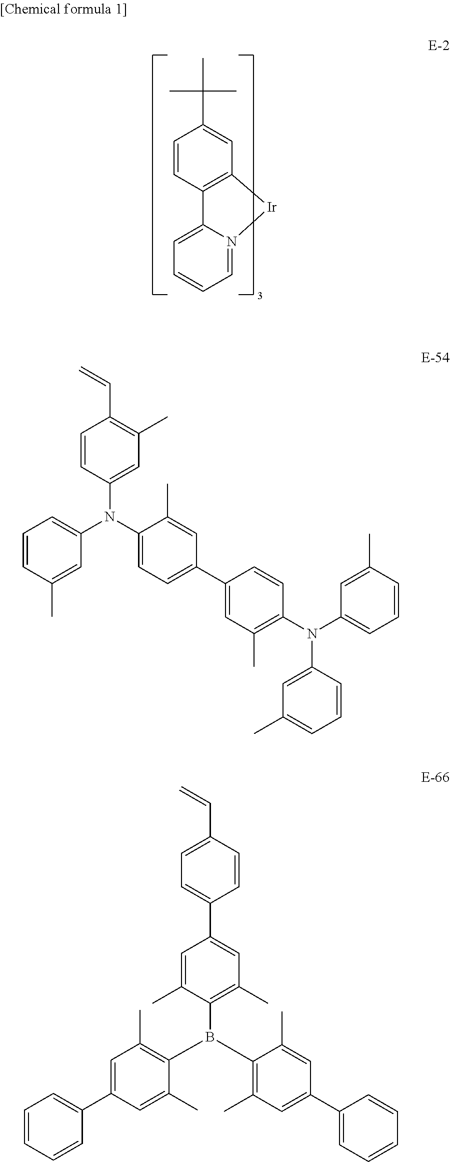

### [Preparation of Light-Emitting Material Solution]

A light-emitting material solution (hereinafter, also referred to as “solution A”) was prepared by dissolving 3 parts by weight of the light-emitting polymer compound prepared as mentioned above (weight-average molecular weight=52000) in 97 parts by weight of xylene.

### [Preparation of Electroluminescent Element]

As an electroluminescent element, the electroluminescent element 10 shown in FIG. 1 was produced by the method described below.

Specifically, first, on a glass substrate made of silica glass (25 mm per side, thickness of 1 mm), an ITO film of 150 nm in thickness was formed by using a sputtering device (E-401s manufactured by Canon ANELVA Corporation). Here, the glass substrate corresponds to the substrate 11. The ITO film corresponds to the anode layer 12.

Next, a photoresist (AZ1500 manufactured by AZ Electronic Materials) of about 1 μm in thickness was formed by a spin coating method. After ultraviolet light exposure, development was executed with 1.2% aqueous solution of TMAH (tetramethyl ammonium hydroxide: (CH₃)₄NOH) for patterning the resist layer. Thereafter, heat was applied for 10 minutes at 130 degrees C. (a post-baking process).

Subsequently, dry etching using a reactive ion etching device (RIE-2001P manufactured by SAMCO Inc.) was performed to etch the ITO film. On this occasion, the etching conditions for ITO film were: using a mixed gas of Cl₂ and SiCl₄ as a reactant gas; and causing a reaction for 8 minutes under a pressure of 1 Pa and output bias/ICP=200/100 (W).

By this dry etching, the recessed portion 16 penetrating the ITO film as the anode layer 12 was formed. Then the residue of the resist was removed by the resist removing solution. The recessed portion 16 was in a cylinder shape with a diameter of 1 μm, and distance between edges 161 of the recessed portion 16 was 1 μm.

Then, a silica dioxide layer (SiO₂) of 120 nm in thickness was formed by using a sputtering device (E-401s manufactured by Canon ANELVA Corporation). By this process, the first low refractive index layer 13 and the second low refractive index layer 19 can be formed together.

Next, the glass substrate was washed by spraying pure water and dried by a spin dryer.

Then the solution A was applied by the spin coating method (spin rate: 3000 rpm), and subsequently, the glass substrate was left under a nitrogen atmosphere at the temperature of 120° C. for an hour, and thus the light emitting portion 17 and the extension portion 17a were formed. It should be noted that the thickness of side surface of the light emitting portion 17 to be in contact with the side surface 12a of the anode layer 12 was 30 nm.

Then, the glass substrate was placed in a vacuum deposition chamber, and a sodium (Na) film having the thickness of 2.0 nm as the cathode buffer layer was formed on the light emitting portion 17 and the extension portion 17a by a vacuum deposition device. Subsequently, an aluminum (Al) film having the thickness of 150 nm as the cathode layer 14 was formed. The electroluminescent element 10 was produced by the aforementioned processes.

### Example 2

The electroluminescent element 10 was produced in the same manner as example 1 except that a magnesium-fluoride layer was formed by using magnesium fluoride (MgF₂) as the material for forming the first low refractive index layer 13 and the second low refractive index layer 19 instead of using silica dioxide (SiO₂). The magnesium-fluoride layer can be formed by a sputtering method similarly to a silica-dioxide layer. The thickness of the magnesium-fluoride layer was set to be 120 nm.

### Example 3

The electroluminescent element 10 was produced in the same manner as example 1 except that a sodium-fluoride layer was formed by using sodium fluoride (NaF) as the material for forming the first low refractive index layer 13 and the second low refractive index layer 19 instead of using silica dioxide (SiO₂). The sodium-fluoride layer can be formed by a vacuum deposition. The thickness of the sodium-fluoride layer was set to be 120 nm.

### Example 4

The electroluminescent element 10d shown in FIG. 4 was produced as an electroluminescent element by changing the following points with respect to the Example 1.

After forming the silica-dioxide (SiO₂) layer having the thickness of 140 nm as the first low refractive index layer 13 and the second low refractive index layer 19, anisotropic etching was performed by using a reactive ion etching device (RIE-2001P manufactured by SAMCO Inc.). On this occasion, the etching conditions were: using CHF₃ as a reactant gas; and causing a reaction for 10 minutes under a pressure of 0.2 Pa and output bias/ICP=120/100 (W).

Thereby, the thickness of the second low refractive index layer 19 was 140 nm, which shows little change, however, the thickness of the first low refractive index layer 13 was 90 nm and formed to be a thin-film. In the exemplary embodiment, the thickness of the side surface of the light emitting portion 17 to be in contact with the side surface 12a of the anode layer 12 is 10 nm. As for other conditions, processes similar to those of the Example 1 were performed.

### Example 5

The electroluminescent element 10e shown in FIG. 5 was produced as an electroluminescent element by changing the following points with respect to the Example 1.

After forming the silica-dioxide (SiO₂) layer having the thickness of 140 nm as the first low refractive index layer 13 and the second low refractive index layer 19, isotropic etching was performed by using a reactive ion etching device (RIE-2001P manufactured by SAMCO Inc.). On this occasion, the etching conditions were: using CHF₃ as a reactant gas; and causing a reaction for 15 minutes under a pressure of 0.7 Pa and output bias/ICP=40/100 (W).

Thereby, the edge portion of the first low refractive index layer 13, which was in contact with the recessed portion 16, was etched to be tapered. Moreover, the light emitting portion 17 was in a state of being in contact with the upper surface 12b of the anode layer 12. As for other conditions, processes similar to those of the Example 1 were performed.

### Example 6

The electroluminescent element 10e shown in FIG. 5 was produced as an electroluminescent element by changing the following points with respect to the Example 1.

The first low refractive index layer 13 and the second low refractive index layer 19 were formed by coating method.

Specifically, silicone of coating type (OCD Type2 Si-49000-SG, manufactured by TOKYO OHKA KOGYO CO., LTD.) was diluted to 50 wt % with a solvent in which ethanol and ethyl acetate were mixed in volume with a ration of 1 to 1. Then, the coating was performed by a spin coater (spin rate of 2000 rpm for 30 seconds). Thereafter, heat treatment was performed at 300° C. for an hour. As a result, a silicone layer which was a base for the first low refractive index layer 13 and the second low refractive index layer 19 was formed as a continuous layer that had a thickness of 130 nm on the anode layer 12 and 160 nm at the bottom portion of the recessed portion 16. In this state, anisotropic etching was performed. Thereby, an end portion of the first low refractive index layer 13 to be in contact with the recessed portion 16 was etched to be tapered. Furthermore, the first low refractive index layer 13 and the second low refractive index layer 19 were separately formed, and each thickness thereof was 100 nm and 140 nm, respectively. The light emitting portion 17 was in a state to be in contact with the side surface 12a of the anode layer 12 with a thickness of 10 nm. As for other conditions, processes similar to those of the Example 1 were performed.

### Example 7

The electroluminescent element 10f shown in FIG. 6 was produced as an electroluminescent element by changing the following points with respect to the Example 1.

After etching the ITO film as the anode layer 12 to form the penetrating part 16a, dry etching was performed by using a reactive ion etching device (RIE-2001P manufactured by SAMCO Inc.). On this occasion, the reactive conditions were: injecting an oxygen gas into the reactive ion etching device; generating an oxygen plasma by applying an AC voltage to discharge an electrical current; and radiating the plasma to a glass substrate. The flow amount of the oxygen gas injected into the plasma generating device was adjusted, and the reaction was performed under a pressure of 1 Pa and an input power of 150 W for 30 seconds. Next, a gas to be injected was changed from the oxygen gas to CHF₃ gas. Here, the flow amount of the gas was adjusted and a pressure was set to be 7 Pa. The reaction was performed in PE mode with an input power of 300 W for 10 seconds. As a result, the bored part 16b with a depth of 100 nm was formed.

Further, the silica-dioxide (SiO₂) layer as the first low refractive index layer 13 and the second low refractive index layer 19 was set to be 200 nm. Therefore, in the exemplary embodiment, the thickness of the side surface of the light emitting portion 17 to be in contact with the side surface 12a of the anode layer 12 was 50 nm. As for other conditions, processes similar to those of the Example 1 were performed.

### Example 8

The electroluminescent element 10g shown in FIG. 7 was produced as an electroluminescent element by changing the following points with respect to the Example 1.

After forming the ITO film as the anode layer 12, the silica-dioxide (SiO₂) layer as the insulating layer 131 was formed with a thickness of 50 nm. Further, the silica-oxide (SiO) layer as the first low refractive index layer 13 and the second low refractive index layer 19 was formed with a thickness of 120 nm. As for other conditions, processes similar to those of the Example 1 were performed.

### Example 9

The electroluminescent element 10 shown in FIG. 1 was produced as an electroluminescent element. On this occasion, the light emitting portion 17 was film-formed by a vacuum deposition method.

That is, in the Example 1, instead of coating with the solution A, a laminated structure disclosed as DEVIDE II in FIG. 1 of a literature (Organic Electronics 2 (2001) P 37-43) was formed. Specifically, a substrate after cleaning was set in a vacuum deposition device, then, αNPD (manufactured by DOJINDO LABORATORIES) of 50 nm, a layer in which CBP (manufactured by DOJINDO LABORATORIES) and Ir(ppy)₃ (manufactured by DOJINDO LABORATORIES) are co-evaporated with a ratio of 95 to 5, and AIQ3 (manufactured by DOJINDO LABORATORIES) of 40 nm were deposited in this order on the substrate, to form the light emitting portion 17.

It should be noted that, in the exemplary embodiment, AgMg layer (weight ratio of 25 to 1) with a thickness of 100 nm was formed as the cathode buffer layer and the cathode layer 14. As for other conditions, processes similar to those of the Example 1 were performed.

### Example 10

The electroluminescent element 10 shown in FIG. 1 was produced as an electroluminescent element. On this occasion, the electroluminescent element 10 was produced in the following method so that the light was able to be extracted from both the lower surface (the anode layer 12 side) and the upper surface (the cathode layer 14 side).

In the Example 1, instead of forming the ITO film as the anode layer 12, a silver (Ag) layer was formed with a thickness of 150 nm on the glass substrate made of silica glass (25 mm per side, thickness of 1 mm) by using the same sputtering device. The silver layer having been formed in this manner was opaque to the visible light.

Etching conditions of the silver layer were; using Cl₂ gas as a reactant gas; and causing a reaction for 6 minutes under a pressure of 1 Pa and output bias/ICP=200/100 (W). As a result, the light was able to be extracted from an area where the silver layer was not formed.

At the occasion of forming the aluminum layer, the thickness thereof was set to be 10 nm, and ITO film was formed thereon with a thickness of 100 nm by a resistance heating deposition method. The cathode layer 14 made of the aluminum layer and the ITO film having been formed in this manner was transparent to the visible light. As for other conditions, processes similar to those of the Example 1 were performed.

### Comparative Example 1

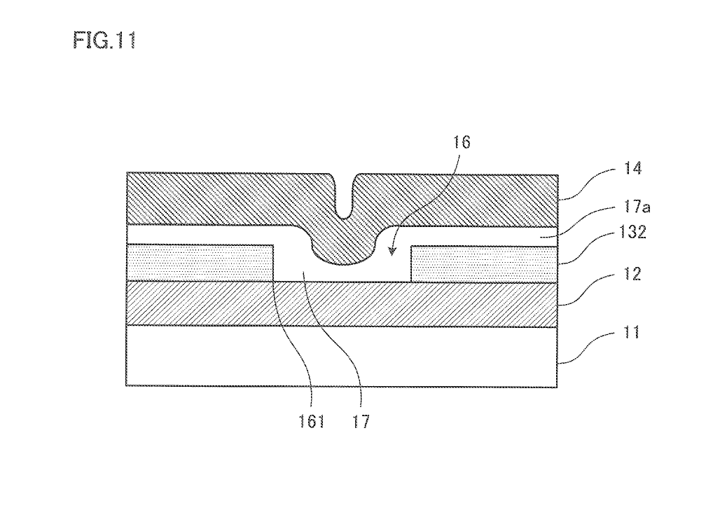

An electroluminescent element having a configuration of FIG. 11 was formed in the following method.

Specifically, first, on a glass substrate made of silica glass (25 mm per side, thickness of 1 mm), an ITO film of 150 nm in thickness and a silica-dioxide (SiO₂) layer of 120 nm in thickness were formed by using a sputtering device (E-401s manufactured by Canon ANELVA Corporation). Here, the glass substrate corresponds to the substrate 11. The ITO film corresponds to the anode layer 12, and the silica-dioxide (SiO₂) layer corresponds to a low refractive index layer 132.

Next, a photoresist (AZ1500 manufactured by AZ Electronic Materials) of about 1 μm in thickness was formed by a spin coating method. After ultraviolet light exposure, development was executed with 1.2% aqueous solution of TMAH (tetramethyl ammonium hydroxide: (CH₃)₄NOH) for patterning the resist layer. Thereafter, heat was applied for 10 minutes at 130 degrees C. (a post-baking process).

Subsequently, dry etching using a reactive ion etching device (RIE-2001P manufactured by SAMCO Inc.) was performed to etch the silica-dioxide layer. On this occasion, the etching conditions for silica-dioxide layer were: using CHF₃ gas as a reactant gas; and causing a reaction for 18 minutes under a pressure of 0.3 Pa and output bias/ICP=50/100 (W).

By this dry etching, the recessed portion 16 penetrating the silica-dioxide layer as the low refractive index layer 132 was formed. Then the residue of the resist was removed by the resist removing solution. The recessed portion 16 was in a cylinder shape with a diameter of 1 μm, and distance between edges 161 of the recessed portion 16 was 1 μm. It should be noted that the ITO film as the anode layer 12 remains as a uniform film without being etched.

Next, the glass substrate was washed by spraying pure water and dried by a spin dryer.

Then the solution A was applied by the spin coating method (spin rate: 3000 rpm), and subsequently, the glass substrate was left under a nitrogen atmosphere at the temperature of 120° C. for an hour, and thus the light emitting portion 17 and the extension portion 17a were formed.

Then, the glass substrate was placed in a vacuum deposition chamber, and a sodium (Na) film having the thickness of 2.0 nm as the cathode buffer layer was formed on the light emitting portion 17 and the extension portion 17a by a vacuum deposition device. Subsequently, an aluminum (Al) film having the thickness of 150 nm as the cathode layer 14 was formed. The electroluminescent element was produced by the aforementioned processes.

### Comparative Example 2

An electroluminescent element having the same configuration as the electroluminescent element illustrated in the Comparative Example 1 was produced as an electroluminescent element. However, the light emitting portion 17 was formed by a vacuum deposition method illustrated in the Example 9. The materials and the laminating configuration at this occasion were similar to those of the Example 9. Further, AgMg layer (weight ratio of 25 to 1) with a thickness of 100 nm was formed as the cathode buffer layer and the cathode layer 14.

### Comparative Example 3

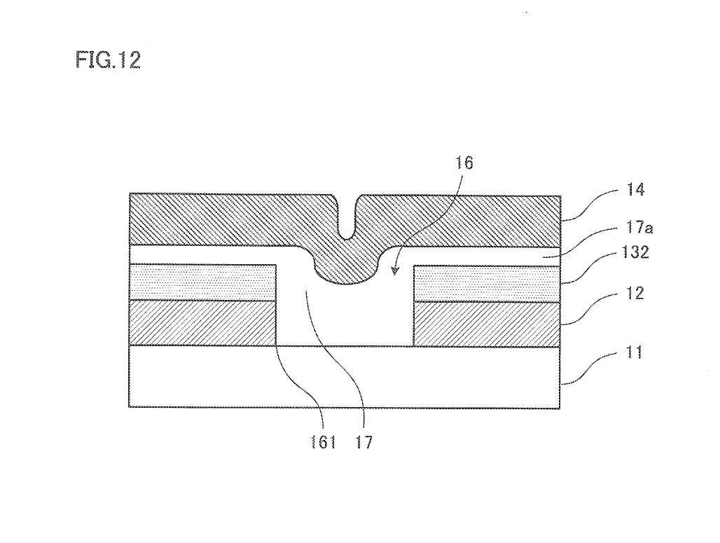

An electroluminescent element having the configuration shown in FIG. 12 was produced as an electroluminescent element by changing the following points with respect to the Comparative Example 1. After forming the ITO film as the anode layer 12, the silica-dioxide (SiO₂) layer as the low refractive index layer 132 was formed with a thickness of 120 nm. Then, the low refractive index layer 132 was patterned by dry etching. Thereafter, subsequently, the ITO film was etched. The etching conditions for ITO film were: using a mixed gas of Cl₂ and SiCl₄ as a reactant gas; and causing a reaction for 8 minutes under a pressure of 1 Pa and output bias/ICP=200/100 (W). By this dry etching, the recessed portion 16 penetrating the ITO film as the anode layer 12 was formed. Then the residue of the resist was removed by the resist removing solution. The recessed portion 16 was in a cylinder shape with a diameter of 1 μm, and distance between edges 161 of the recessed portion 16 was 1 μm.

### Comparative Example 4

An electroluminescent element having the same configuration as the electroluminescent element illustrated in the Comparative Example 3 was produced as an electroluminescent element. However, following points were changed with respect to the Comparative Example 3. That is, instead of forming the ITO film as the anode layer 12, a silver (Ag) layer was formed with a thickness of 150 nm by using the same sputtering device. Then a silica-dioxide (SiO₂) layer as the low refractive index layer 132 of 120 nm in thickness was formed. Thereafter, the low refractive index layer 132 was etched, and the silver layer was subsequently etched. Etching conditions of the silver layer were; using Cl₂ gas as a reactant gas; and causing a reaction for 6 minutes under a pressure of 1 Pa and output bias/ICP=200/100 (W). As a result, the light was able to be extracted from an area where the silver layer was not formed.

At the occasion of forming the aluminum layer, the thickness thereof was set to be 10 nm, and ITO film was formed thereon with a thickness of 100 nm by a resistance heating deposition method. The cathode layer 14 made of the aluminum layer and the ITO film having been formed in this manner was transparent to the visible light. As for other conditions, processes similar to those of the Example 3 were performed.

Voltage was gradually applied to the electroluminescent elements produced in the Examples 1 to 10 and the Comparative Examples 1 to 4 by using a constant-voltage power supply (SM2400 manufactured by Keithley Instruments, KK) to measure an emission intensity with a brightness meter (BM-9 manufactured by TOPCON CORPORATION). From the ratio of the emission intensity to the current density, the light-emitting efficiency was determined. In the Example 10, however, since the light was emitted from the upper surface (the cathode layer 14 side) in addition to the lower surface (the anode layer 12 side), the light-emitting efficiency was set to be a sum total of measured values at the upper surface and the lower surface.

Moreover, the refractive index of the second low refractive index layer 19 was measured in the case of a light with a wavelength of 550 nm.

Table 1 shows the result. It should be noted that the result of the light-emitting efficiency is a numerical value normalized as that of the Comparative Example 1 to be 1.0. Regarding the Comparative Examples 1 to 4, the refractive index of the light emitting portion 17 was recorded to compare with the second low refractive index layer 19.

TABLE 1

| | Second low refractive index layer | | Light-emitting |
|---|---|---|---|
| | Material | Refractive index | efficiency |
| Example 1 | SiO₂ | 1.45 | 1.3 |
| Example 2 | MgF₂ | 1.38 | 1.4 |
| Example 3 | NaF | 1.32 | 1.45 |
| Example 4 | SiO₂ | 1.46 | 1.35 |
| Example 5 | SiO₂ | 1.46 | 1.35 |
| Example 6 | Silicone | 1.43 | 1.3 |
| Example 7 | SiO₂ | 1.46 | 1.6 |
| Example 8 | SiO | 1.55 | 1.3 |
| Example 9 | SiO₂ | 1.46 | 0.9 |
| Example 10 | SiO₂ | 1.46 | 1.1 |
| Comparative | Not provided | 1.68 | 1.0 |
| Example 1 | | (Light emitting portion) | |
| Comparative | Not provided | 1.68 | 0.7 |
| Example 2 | | (Light emitting portion) | |
| Comparative | Not provided | 1.68 | 1.1 |
| Example 3 | | (Light emitting portion) | |
| Comparative | Not provided | 1.68 | 0.8 |
| Example 4 | | (Light emitting portion) | |

Comparing the Examples 1 to 3 with the Comparative Examples 1 and 3, it is found that a better light-emitting efficiency is obtained in the case where the first low refractive index layer 13 and the second low refractive index layer 19 are formed. In addition, in the producing method shown in the Example 1, compared with the producing method shown in the Comparative Example 3, only the ITO film as the anode layer 12 is etched. Therefore, in the Example 1, it is not necessary to perform a dry etching on the second low refractive index layer 19 and the anode layer 12 successively as it is in the Comparative Example 3, thus the Example 1 has an advantage of being able to stably produce an electroluminescent element. Comparing the Examples 1 to 3 with each other, the light-emitting efficiency is better in the Example 2 than in the Example 1, and much better in the Example 3 than in the Example 1. This is considered to be due to difference in materials forming the first low refractive index layer 13 and the second low refractive index layer 19. In other words, it is considered that magnesium fluoride (MgF₂) and sodium fluoride (NaF) respectively used in the Examples 2 and 3 have lower refractive index than silica-dioxide (SiO₂) used in the Example 1, and the light-emitting efficiency is better in a case of using the material having lower refractive index. As in the Example 3, the light-emitting efficiency is better even in the case where sodium fluoride (NaF) that is soluble in water and difficult to perform a photolithography is used, which leads to the following that the material which can be formed in a vacuum deposition method may be used.

Next, comparing the Examples 4 to 8 with the Comparative Examples 1 and 3, it is found that the light-emitting efficiency is improved in each Example than in each Comparative Example. By these results, it is found that the light-emitting efficiency is improved even in the case as in the Example 4 where the first low refractive index layer 13 is thinner than the second low refractive index layer 19. Moreover, it is found that the light-emitting efficiency is improved even in the case as in the Example 5 where the light emitting portion 17 is in contact with the upper surface of the anode layer 12.

Furthermore, the light-emitting efficiency is better even in the case as in the Example 6 where the first low refractive index layer 13 and the second low refractive index layer 19 are formed by coating method, which leads to the following that coating method can be adopted in forming the first low refractive index layer 13 and the second low refractive index layer 19. By adopting coating method, the advantages of; (1) there are more options of applicable materials since the materials that can be formed only by the film-coating are able to be used (in other words, a material that is more inexpensive than a material formed by vacuum forming like sputtering, or a coating material having good characteristics are applicable.); and (2) film-forming by coating method is generally more inexpensive (equipment thereof is more inexpensive) than film-forming by vacuum forming like sputtering and the like are obtained.

Comparing the Examples 1 and 7, it is found that the light-emitting efficiency is better in the case where the bored part 16b is formed, and by forming the bored part 16b, the light-emitting efficiency is much improved.

In the Example 8, silicone (SiO), which is conductive silicone oxide, is used as the first low refractive index layer 13 and the second low refractive index layer 19, and the insulating layer 131 is formed on the first low refractive index layer 13. The light-emitting efficiency is improved even in this case, therefore the conductive material as the low refractive index layer may be used.

Furthermore, the Example 10 and the Comparative Examples 1 and 4 are compared. In the Example 10 and the Comparative Example 4, the light can be extracted from both sides of the anode layer 12 and the cathode layer 14. The light-emitting efficiency in the Example 10 is better than that in the Comparative Example 1, and it is found that providing the first low refractive index layer 13 and the second low refractive index layer 19 is effective. However, compared with the Example 1, the light-emitting efficiency is lowered since the light from the cathode layer 14 side passes through the ITO film. The material and thickness of the anode layer 12 and the cathode layer 14 in the Example 10 are different from those in the Comparative Example 1, thus it is found that the light-emitting efficiency is improved compared with the Comparative Example 4, which is similarly produced. By this, it may be said that providing the second low refractive index layer 19 is effective even in the configuration where the electrode materials are used and the light is extracted from both sides as in the Example 10. Furthermore, in the Example 10, compared with the Comparative Example 4, the step between a bottom surface at the recessed portion 16 of the light emitting portion 17, and an upper portion of the first low refractive index layer 13 and the low refractive index layer 132 is made smaller, thereby coverage property thereof is improved when the light emitting portion 17 and the extension portion 17a are formed. Therefore, electroluminescent elements that are less likely to be short-circuited can be formed stably.

On the other hand, the light emitting portion 17 is formed by vacuum deposition method in the Example 9 and the Comparative Example 2. From the results of the Example 9 and the Comparative Example 2, it is found that the electroluminescent element excellent in light-emitting efficiency can be produced by providing the first low refractive index layer 13 and the second low refractive index layer 19. However, comparing the Example 9 with the Example 1, the light-emitting efficiency is better in forming the light emitting portion 17 by coating method. This may be because, in the vacuum deposition method, the light-emitting material is difficult to be filled in the recessed portion 16 with a uniform thickness compared with coating method.

### REFERENCE SIGNS LIST

10 . . . Electroluminescent element
11 . . . Substrate
12 . . . Anode layer
13 . . . First low refractive index layer
14 . . . Cathode layer
16 . . . Recessed portion
16a . . . Penetrating part
16b . . . Bored part
17 . . . Light emitting portion
19 . . . Second low refractive index layer
200 . . . Display device
300 . . . Illuminating device

1. An electroluminescent element comprising:
a first electrode layer;
a second electrode layer;
a first low refractive index layer that is formed between the first electrode layer and the second electrode layer;
a recessed portion that penetrates at least the first electrode layer and the first low refractive index layer;
a second low refractive index layer that is formed on a bottom portion of the recessed portion; and
a light emitting portion that is formed on the second low refractive index layer, wherein
a refractive index of the first low refractive index layer and a refractive index of the second low refractive index layer are smaller than a refractive index of the light emitting portion.

2. The electroluminescent element according to claim 1, wherein the first low refractive index layer has insulating properties.

3. The electroluminescent element according to claim 1 wherein a thickness of the first low refractive index layer is thinner than a thickness of the second low refractive index layer.

4. The electroluminescent element according to claim 1, wherein the light emitting portion is in contact with a side surface of the first electrode layer.

5. The electroluminescent element according to claim 4, wherein the light emitting portion is further in contact with an upper surface of the first electrode layer.

6. The electroluminescent element according to claim 1, wherein the light emitting portion contains a phosphorescent light-emitting organic material.

7. The electroluminescent element according to claim 1, wherein a width of the recessed portion is 10 μm or less.

8. The electroluminescent element according to claim 1, further comprising a plurality of the recessed portions, wherein
the recessed portion has a substantially cylinder shape or a trench shape being parallel to the trench shape of other recessed portions.

9. The electroluminescent element according to claim 1, further comprising a substrate on which the first electrode layer is formed, wherein
the recessed portion includes a penetrating part that is formed to penetrate at least the first electrode layer and the first low refractive index layer, and a bored part that is formed in the substrate.

10. A method for manufacturing an electroluminescent element comprising:
a first electrode layer forming process in which a first electrode layer is formed on a substrate;
a recessed portion forming process in which a recessed portion is formed in the first electrode layer before a first low refractive index layer and a second low refractive index layer are formed;
a second low refractive index layer forming process in which the second low refractive index layer is formed on a bottom surface of the recessed portion;
a first low refractive index layer forming process in which the first low refractive index layer is formed on the first electrode layer;
a light emitting portion forming process in which a light emitting portion containing a light-emitting material is formed on the first low refractive index layer and the second low refractive index layer; and
a second electrode layer forming process in which a second electrode layer is formed on the light-emitting material.

11. A method for manufacturing an electroluminescent element comprising:
a first electrode layer forming process in which a first electrode layer is formed on a substrate;
a recessed portion forming process in which a recessed portion is formed in the first electrode layer;
a low refractive index layer forming process in which a first low refractive index layer and a second low refractive index layer are formed together;
a light emitting portion forming process in which a light emitting portion containing a light-emitting material is formed on the first low refractive index layer and the second low refractive index layer; and
a second electrode layer forming process in which a second electrode layer is formed on the light-emitting material.

12. The method for manufacturing an electroluminescent element according to claim 11, further comprising a film thinning process in which a thickness of the second low refractive index layer is made small, between the low refractive index layer forming process and the light emitting portion forming process.

13. The method for manufacturing an electroluminescent element according to claim 12, further comprising an electrode layer exposure process in which a part of the first electrode layer is exposed, between the film thinning process and the light emitting portion forming process.

14. The method for manufacturing an electroluminescent element according to claim 11, wherein, in the recessed portion forming process, the recessed portion is formed by penetrating the first electrode layer and the substrate together.

15. A display device comprising the electroluminescent element according to claim 1.

16. An illuminating device comprising the electroluminescent element according to claim 1.
